(19) United States
(12) Patent Application Publication
(10) Pub. No.: US 2017/0132833 A1
(43) Pub. Date: May 11, 2017

(54) PROGRAMMABLE PER PIXEL SAMPLE PLACEMENT USING CONSERVATIVE RASTERIZATION

(71) Applicant: INTEL CORPORATION, Santa Clara, CA (US)

(72) Inventor: Rahul P. Sathe, Folsom, CA (US)

(73) Assignee: INTEL CORPORATION, Santa Clara, CA (US)

(21) Appl. No.: 14/937,438

(22) Filed: Nov. 10, 2015

(51) Int. Cl. G06T 15/80; G06T 15/04; G06T 1/20

(52) U.S. Cl. CPC G06T 15/80; G06T 1/20; G06T 15/04

(57) ABSTRACT

A graphics processing apparatus comprising a graphics processing pipeline including shader execution logic to execute shading instructions. The shading instructions causes the shader execution logic to programmatically determine a sample location for multiple pixels within a frame. The sample locations are determined based on a location of the pixel within the frame and can be determined by shader logic provided to the graphic processing apparatus by a graphics application.

### FIELD OF THE DISCLOSURE

Embodiments are generally related to graphics processor devices, and more particularly to programmable per pixel sample placement using conservative rasterization.

### DESCRIPTION OF THE RELATED ART

Rasterization is a process by which a scene of three-dimensional (3D) polygons is rendered onto a two-dimensional (2D) surface. The rasterization process can be performed in several stages, including a transformation stage, a clipping stage, and a scan conversion stage. The transformation stage converts 3D polygon vertices to vertices on a 2D plane. Once the vertices are transformed to 2D locations, some of vertices may lie may be outside of the viewing window for the scene. The set of vertices may be clipped, such that only vertices within the scene receive further processing. Once the 3D polygons are transformed to a 2D location and clipped into a viewing window, a scan conversion process is performed to determine which pixels are used to draw the image.

Typically, pixels centers are aligned in a regular grid across the screen in consumer class graphics hardware. This makes designing rasterization hardware relatively easier. However at low resolutions, this regular arrangement of visibility and shading samples introduces aliasing. Aliasing is an effect that results when a signal or image that is reconstructed from samples is different from the original continuous signal. When rendering a two-dimensional (2D) image of three-dimensional (3D) objects, aliasing can manifest as jagged lines that follow the boundaries between pixels.

### BRIEF DESCRIPTION OF THE DRAWINGS

The following description includes discussion of figures having illustrations given by way of example of implementations of the various embodiments. The figures should be understood by way of example and not by way of limitation.

FIG. 1 is a block diagram of an embodiment of a computer system with a processor having one or more processor cores and graphics processors.

FIG. 2 is a block diagram of one embodiment of a processor having one or more processor cores, an integrated memory controller, and an integrated graphics processor.

FIG. 3 is a block diagram of one embodiment of a graphics processor which may be a discreet graphics processing unit, or may be graphics processor integrated with a plurality of processing cores.

FIG. 4 is a block diagram of an embodiment of a graphics-processing engine for a graphics processor.

FIG. 5 is a block diagram of another embodiment of a graphics processor.

FIG. 6 is a block diagram of thread execution logic including an array of processing elements.

FIG. 7 illustrates a graphics processor execution unit instruction format according to an embodiment.

FIG. 8 is a block diagram of another embodiment of a graphics processor.

FIG. 9A is a block diagram illustrating a graphics processor command format according to an embodiment.

FIG. 9B is a block diagram illustrating a graphics processor command sequence according to an embodiment.

FIG. 10 illustrates exemplary graphics software architecture for a data processing system according to an embodiment.

FIG. 11 is a block diagram illustrating an IP core development system that may be used to manufacture an integrated circuit to perform operations according to an embodiment;

FIG. 12 is a block diagram illustrating an exemplary system on a chip integrated circuit that may be fabricated using one or more IP cores, according to an embodiment;

FIG. 13 is a block diagram of a graphics pipeline 1300 with programmable per pixel sample placement, according to an embodiment;

FIG. 14 is a detailed block diagram of graphic core logic, according to an embodiment;

FIG. 15 is a flow diagram of sample placement and shading logic, according to an embodiment; and

FIG. 16 is a block diagram of a computing device including a graphics pipeline configured to perform pixel shading with per pixel sample placement, according to an embodiment.

### DETAILED DESCRIPTION

Multi-sampling anti-aliasing (MSAA) has been a popular technique used to alleviate issues caused by aliasing. MSAA samples the visibility at the higher rate, but restricts the shading rate to “once per primitive per pixel”. Modern graphics application programming interfaces (APIs) such as Microsoft's Direct3D® and the Kronos Group's Vulkan™ APIs do not define the precise positions of the samples within a pixel. Typically, there are more horizontal and vertical lines in the scenes, so to further reduce aliasing effects, MSAA samples are placed along a rotated grid within a pixel. However, the positions of these MSAA samples are identical across all pixels.

An alternative mechanism that may be used is known as stratified sampling. Stratified sampling may be used to reduce aliasing effects by jittering the sample positions from the pixel centers or uniform MSAA grids. The jittering of samples replaces the aliasing with potentially less objectionable high frequency noise (e.g., blue noise).

Described herein, in various embodiments, is a mechanism to enable the programmatic placement of samples at any location within a pixel. Because the technique is programmable, the graphics application developers are provided complete control of where to place pixel samples within a pixel, enabling the developers to create rich sample patterns. Additionally, the samples may be placed in parallels for all of the pixels. While samples may be placed in parallel for all pixels, if multiple samples can be serially generated for a given pixel. Programmable per-pixel sample positions can allow graphics application developers to leverage programmable pixel shading hardware within consumer grade graphics products to implement advanced anti-aliasing techniques such as temporal super-sampling without requiring the use of dedicated hardware solutions.

In one embodiment, programmable per pixel sample placement is performed using a conservative rasterizer. Conservative rasterization means that all pixels that are at least partially covered by a rendered primitive are rasterized, which means that the pixel shader is invoked for that pixel. This differs from the normal sampling behavior, which is not used if conservative rasterization is enabled. Conservative Rasterization may be useful in situations such as collision detection, occlusion culling, tiled rendering, and other situations in which an enhanced degree of rasterization certainty is beneficial. A conservative rasterizer rasterizes any pixel where the pixel coverage could have non-zero coverage even though the triangle may not cover any discrete visibility sample in that pixel.

In embodiments described herein, the rasterizer is configured for conservative rasterization and the post-clipping edge equations for a triangle are passed to the pixel shader. This enables a developer to programmatically position samples anywhere within the pixel and then use the placed samples to perform an “in-out” test for the triangle edges programmatically using the programmable pixel sharing hardware. If the sample(s) are found to be inside the triangle, the developer uses the pull mode interpolation followed by the shading calculations at that sample location(s). Otherwise, if the desired sample is found to be outside of the triangle, user simply discards the pixel. If the sample(s) is found to be on the triangle edge, programmer may use the same rules that are used by the conventional rasterizer.

For the purposes of explanation, numerous specific details are set forth to provide a thorough understanding of the various embodiments described below. However, it will be apparent to a skilled practitioner in the art that the embodiments may be practiced without some of these specific details. In other instances, well-known structures and devices are shown in block diagram form to avoid obscuring the underlying principles, and to provide a more thorough understanding of embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

Although some of the following embodiments are described with reference to a processor, similar techniques and teachings can be applied to other types of circuits or semiconductor devices, as the teachings are applicable to any processor or machine that performs data manipulations.

System Overview

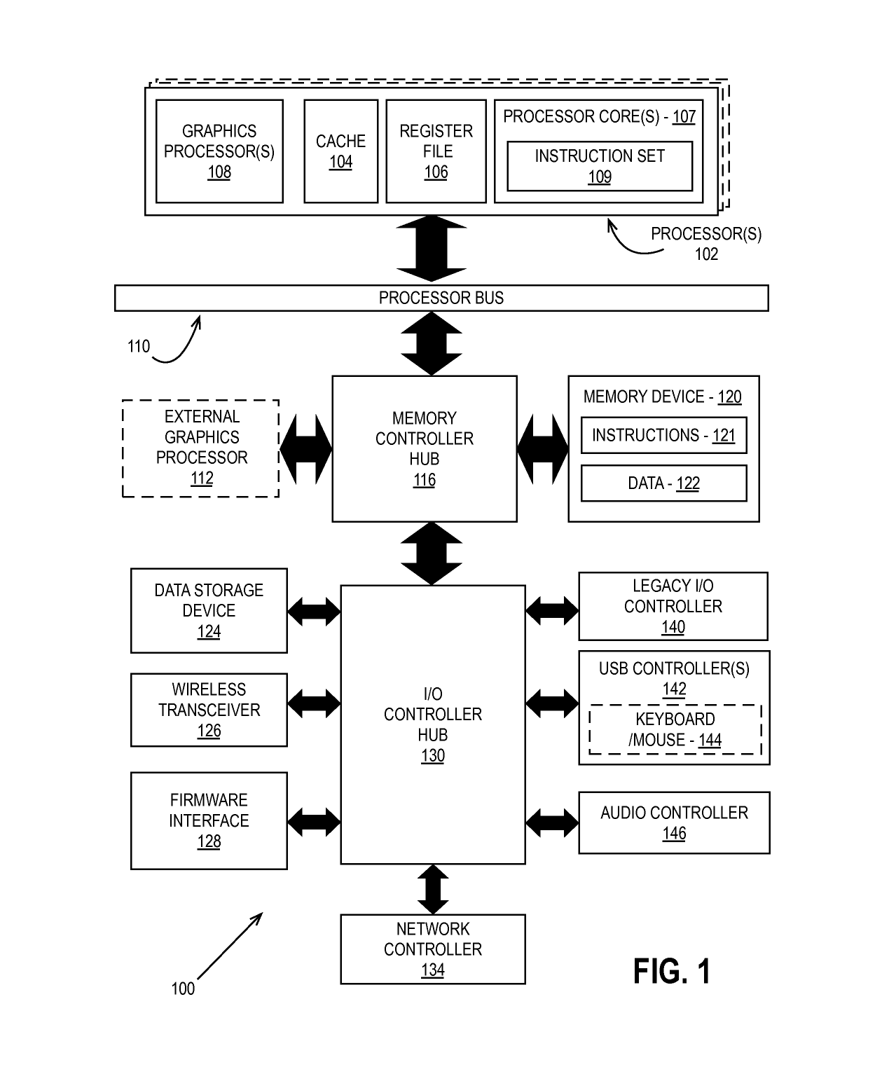

FIG. 1 is a block diagram of a processing system 100, according to an embodiment. In various embodiments the system 100 includes one or more processors 102 and one or more graphics processors 108, and may be a single processor desktop system, a multiprocessor workstation system, or a server system having a large number of processors 102 or processor cores 107. In on embodiment, the system 100 is a processing platform incorporated within a system-on-a-chip (SoC) integrated circuit for use in mobile, handheld, or embedded devices.

An embodiment of system 100 can include, or be incorporated within a server-based gaming platform, a game console, including a game and media console, a mobile gaming console, a handheld game console, or an online game console. In some embodiments system 100 is a mobile phone, smart phone, tablet computing device or mobile Internet device. Data processing system 100 can also include, couple with, or be integrated within a wearable device, such as a smart watch wearable device, smart eyewear device, augmented reality device, or virtual reality device. In some embodiments, data processing system 100 is a television or set top box device having one or more processors 102 and a graphical interface generated by one or more graphics processors 108.

In some embodiments, the one or more processors 102 each include one or more processor cores 107 to process instructions which, when executed, perform operations for system and user software. In some embodiments, each of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). Multiple processor cores 107 may each process a different instruction set 109, which may include instructions to facilitate the emulation of other instruction sets. Processor core 107 may also include other processing devices, such a Digital Signal Processor (DSP).

In some embodiments, the processor 102 includes cache memory 104. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 is additionally included in processor 102 which may include different types of registers for storing different types of data (e.g., integer registers, floating point registers, status registers, and an instruction pointer register). Some registers may be general-purpose registers, while other registers may be specific to the design of the processor 102.

In some embodiments, processor 102 is coupled to a processor bus 110 to transmit communication signals such as address, data, or control signals between processor 102 and other components in system 100. In one embodiment the system 100 uses an exemplary ‘hub’ system architecture, including a memory controller hub 116 and an Input Output (I/O) controller hub 130. A memory controller hub 116 facilitates communication between a memory device and other components of system 100, while an I/O Controller Hub (ICH) 130 provides connections to I/O devices via a local I/O bus. In one embodiment, the logic of the memory controller hub 116 is integrated within the processor.

Memory device 120 can be a dynamic random access memory (DRAM) device, a static random access memory (SRAM) device, flash memory device, phase-change memory device, or some other memory device having suitable performance to serve as process memory. In one embodiment the memory device 120 can operate as system memory for the system 100, to store data 122 and instructions 121 for use when the one or more processors 102 executes an application or process. Memory controller hub 116 also couples with an optional external graphics processor 112, which may communicate with the one or more graphics processors 108 in processors 102 to perform graphics and media operations.

In some embodiments, ICH 130 enables peripherals to connect to memory device 120 and processor 102 via a high-speed I/O bus. The I/O peripherals include, but are not limited to, an audio controller 146, a firmware interface 128, a wireless transceiver 126 (e.g., Wi-Fi, Bluetooth), a data storage device 124 (e.g., hard disk drive, flash memory, etc.), and a legacy I/O controller 140 for coupling legacy (e.g., Personal System 2 (PS/2)) devices to the system. One or more Universal Serial Bus (USB) controllers 142 connect input devices, such as keyboard and mouse 144 combinations. A network controller 134 may also couple to ICH 130. In some embodiments, a high-performance network controller (not shown) couples to processor bus 110. It will be appreciated that the system 100 shown is exemplary and not limiting, as other types of data processing systems that are differently configured may also be used. For example, the I/O controller hub 130 may be integrated within the one or more processor 102, or the memory controller hub 116 and I/O controller hub 130 may be integrated into a discreet external graphics processor, such as the external graphics processor 112.

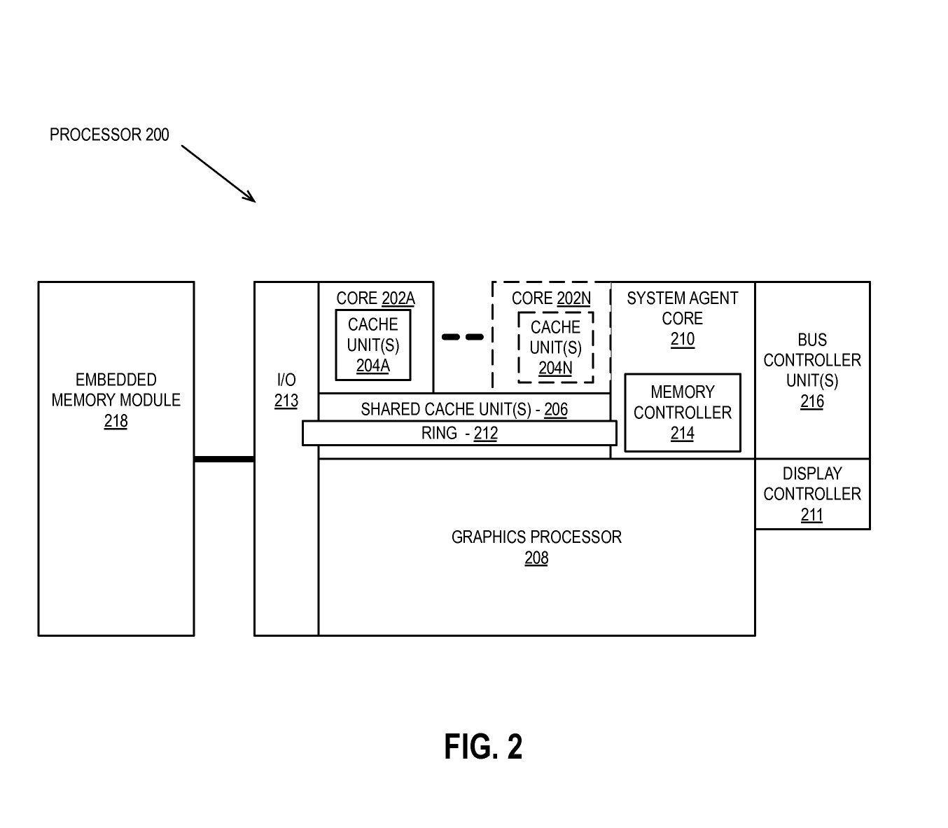

FIG. 2 is a block diagram of an embodiment of a processor 200 having one or more processor cores 202A-202N, an integrated memory controller 214, and an integrated graphics processor 208. Those elements of FIG. 2 having the same reference numbers (or names) as the elements of any other figure herein can operate or function in any manner similar to that described elsewhere herein, but are not limited to such. Processor 200 can include additional cores up to and including additional core 202N represented by the dashed lined boxes. Each of processor cores 202A-202N includes one or more internal cache units 204A-204N. In some embodiments each processor core also has access to one or more shared cached units 206.

The internal cache units 204A-204N and shared cache units 206 represent a cache memory hierarchy within the processor 200. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 206 and 204A-204N.

In some embodiments, processor 200 may also include a set of one or more bus controller units 216 and a system agent core 210. The one or more bus controller units 216 manage a set of peripheral buses, such as one or more Peripheral Component Interconnect buses (e.g., PCI, PCI Express). System agent core 210 provides management functionality for the various processor components. In some embodiments, system agent core 210 includes one or more integrated memory controllers 214 to manage access to various external memory devices (not shown).

In some embodiments, one or more of the processor cores 202A-202N include support for simultaneous multi-threading. In such embodiment, the system agent core 210 includes components for coordinating and operating cores 202A-202N during multi-threaded processing. System agent core 210 may additionally include a power control unit (PCU), which includes logic and components to regulate the power state of processor cores 202A-202N and graphics processor 208.

In some embodiments, processor 200 additionally includes graphics processor 208 to execute graphics processing operations. In some embodiments, the graphics processor 208 couples with the set of shared cache units 206, and the system agent core 210, including the one or more integrated memory controllers 214. In some embodiments, a display controller 211 is coupled with the graphics processor 208 to drive graphics processor output to one or more coupled displays. In some embodiments, display controller 211 may be a separate module coupled with the graphics processor via at least one interconnect, or may be integrated within the graphics processor 208 or system agent core 210.

In some embodiments, a ring based interconnect unit 212 is used to couple the internal components of the processor 200. However, an alternative interconnect unit may be used, such as a point-to-point interconnect, a switched interconnect, or other techniques, including techniques well known in the art. In some embodiments, graphics processor 208 couples with the ring interconnect 212 via an I/O link 213.

The exemplary I/O link 213 represents at least one of multiple varieties of I/O interconnects, including an on package I/O interconnect which facilitates communication between various processor components and a high-performance embedded memory module 218, such as an eDRAM module. In some embodiments, each of the processor cores 202-202N and graphics processor 208 use embedded memory modules 218 as a shared Last Level Cache.

In some embodiments, processor cores 202A-202N are homogenous cores executing the same instruction set architecture. In another embodiment, processor cores 202A-202N are heterogeneous in terms of instruction set architecture (ISA), where one or more of processor cores 202A-N execute a first instruction set, while at least one of the other cores executes a subset of the first instruction set or a different instruction set. In one embodiment processor cores 202A-202N are heterogeneous in terms of microarchitecture, where one or more cores having a relatively higher power consumption couple with one or more power cores having a lower power consumption. Additionally, processor 200 can be implemented on one or more chips or as an SoC integrated circuit having the illustrated components, in addition to other components.

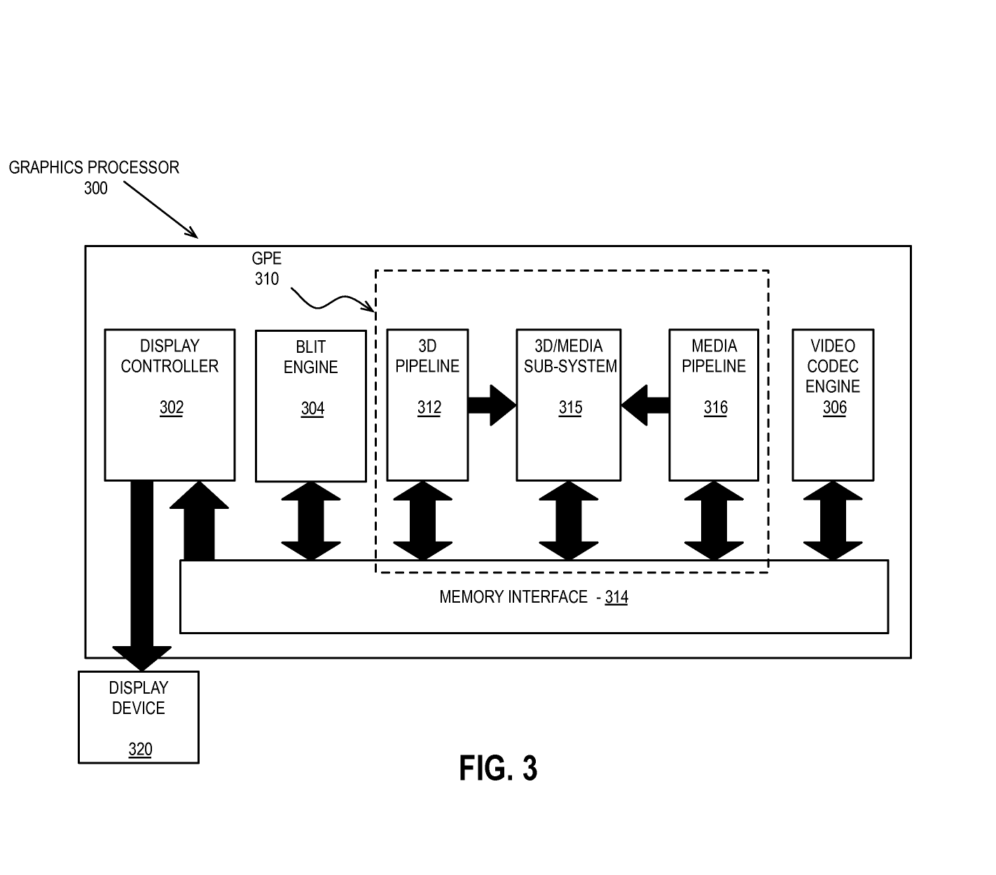

FIG. 3 is a block diagram of a graphics processor 300, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 300 includes a memory interface 314 to access memory. Memory interface 314 can be an interface to local memory, one or more internal caches, one or more shared external caches, and/or to system memory.

In some embodiments, graphics processor 300 also includes a display controller 302 to drive display output data to a display device 320. Display controller 302 includes hardware for one or more overlay planes for the display and composition of multiple layers of video or user interface elements. In some embodiments, graphics processor 300 includes a video codec engine 306 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421 M/VC-1, and Joint Photographic Experts Group (JPEG) formats such as JPEG, and Motion JPEG (MJPEG) formats.

In some embodiments, graphics processor 300 includes a block image transfer (BLIT) engine 304 to perform two-dimensional (2D) rasterizer operations including, for example, bit-boundary block transfers. However, in one embodiment, 2D graphics operations are performed using one or more components of graphics processing engine (GPE) 310. In some embodiments, graphics processing engine 310 is a compute engine for performing graphics operations, including three-dimensional (3D) graphics operations and media operations.

In some embodiments, GPE 310 includes a 3D pipeline 312 for performing 3D operations, such as rendering three-dimensional images and scenes using processing functions that act upon 3D primitive shapes (e.g., rectangle, triangle, etc.). The 3D pipeline 312 includes programmable and fixed function elements that perform various tasks within the element and/or spawn execution threads to a 3D/Media sub-system 315. While 3D pipeline 312 can be used to perform media operations, an embodiment of GPE 310 also includes a media pipeline 316 that is specifically used to perform media operations, such as video post-processing and image enhancement.

In some embodiments, media pipeline 316 includes fixed function or programmable logic units to perform one or more specialized media operations, such as video decode acceleration, video de-interlacing, and video encode acceleration in place of, or on behalf of video codec engine 306. In some embodiments, media pipeline 316 additionally includes a thread spawning unit to spawn threads for execution on 3D/Media sub-system 315. The spawned threads perform computations for the media operations on one or more graphics execution units included in 3D/Media sub-system 315.

In some embodiments, 3D/Media subsystem 315 includes logic for executing threads spawned by 3D pipeline 312 and media pipeline 316. In one embodiment, the pipelines send thread execution requests to 3D/Media subsystem 315, which includes thread dispatch logic for arbitrating and dispatching the various requests to available thread execution resources. The execution resources include an array of graphics execution units to process the 3D and media threads. In some embodiments, 3D/Media subsystem 315 includes one or more internal caches for thread instructions and data. In some embodiments, the subsystem also includes shared memory, including registers and addressable memory, to share data between threads and to store output data.

### 3D/Media Processing

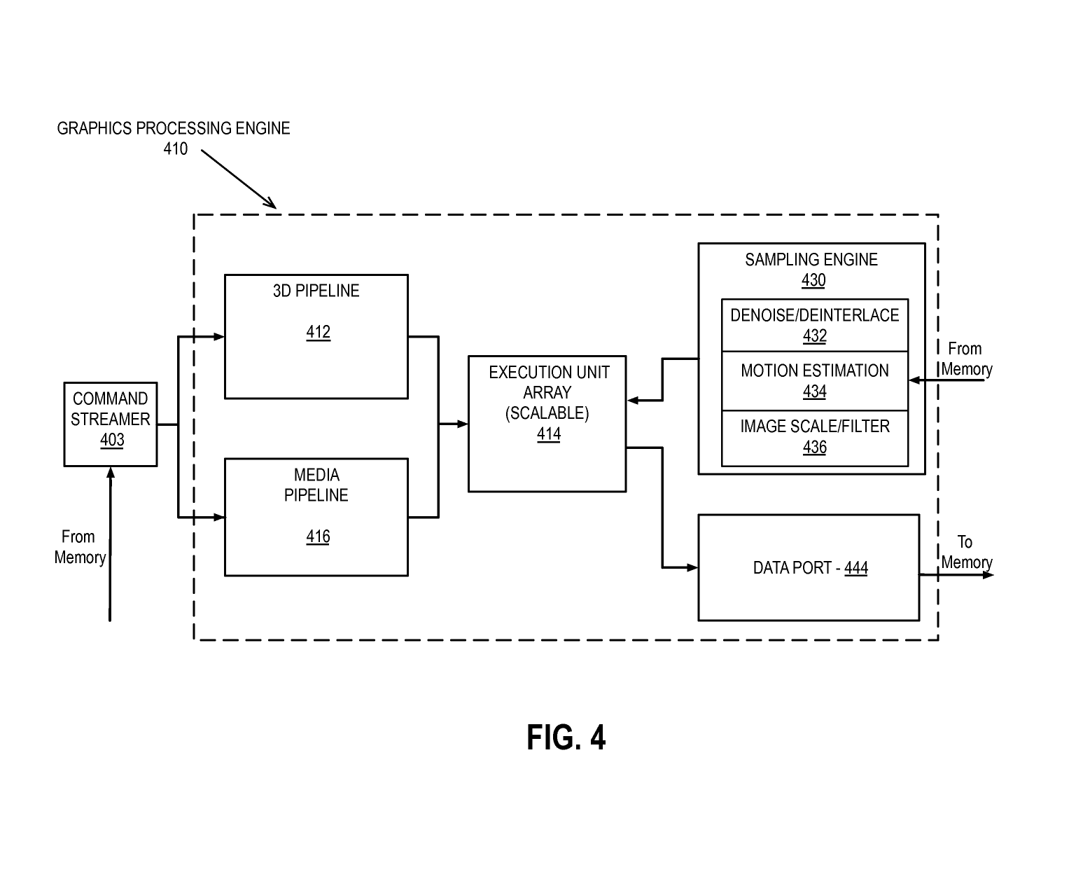

FIG. 4 is a block diagram of a graphics processing engine 410 of a graphics processor in accordance with some embodiments. In one embodiment, the GPE 410 is a version of the GPE 310 shown in FIG. 3. Elements of FIG. 4 having the same reference numbers (or names) as the elements of any other figure herein can operate or function in any manner similar to that described elsewhere herein, but are not limited to such.

In some embodiments, GPE 410 couples with a command streamer 403, which provides a command stream to the GPE 3D and media pipelines 412, 416. In some embodiments, command streamer 403 is coupled to memory, which can be system memory, or one or more of internal cache memory and shared cache memory. In some embodiments, command streamer 403 receives commands from the memory and sends the commands to 3D pipeline 412 and/or media pipeline 416. The commands are directives fetched from a ring buffer, which stores commands for the 3D and media pipelines 412, 416. In one embodiment, the ring buffer can additionally include batch command buffers storing batches of multiple commands. The 3D and media pipelines 412, 416 process the commands by performing operations via logic within the respective pipelines or by dispatching one or more execution threads to an execution unit array 414. In some embodiments, execution unit array 414 is scalable, such that the array includes a variable number of execution units based on the target power and performance level of GPE 410.

In some embodiments, a sampling engine 430 couples with memory (e.g., cache memory or system memory) and execution unit array 414. In some embodiments, sampling engine 430 provides a memory access mechanism for execution unit array 414 that allows execution array 414 to read graphics and media data from memory. In some embodiments, sampling engine 430 includes logic to perform specialized image sampling operations for media.

In some embodiments, the specialized media sampling logic in sampling engine 430 includes a de-noise/de-interlace module 432, a motion estimation module 434, and an image scaling and filtering module 436. In some embodiments, de-noise/de-interlace module 432 includes logic to perform one or more of a de-noise or a de-interlace algorithm on decoded video data. The de-interlace logic combines alternating fields of interlaced video content into a single fame of video. The de-noise logic reduces or removes data noise from video and image data. In some embodiments, the de-noise logic and de-interlace logic are motion adaptive and use spatial or temporal filtering based on the amount of motion detected in the video data. In some embodiments, the de-noise/de-interlace module 432 includes dedicated motion detection logic (e.g., within the motion estimation engine 434).

In some embodiments, motion estimation engine 434 provides hardware acceleration for video operations by performing video acceleration functions such as motion vector estimation and prediction on video data. The motion estimation engine determines motion vectors that describe the transformation of image data between successive video frames. In some embodiments, a graphics processor media codec uses video motion estimation engine 434 to perform operations on video at the macro-block level that may otherwise be too computationally intensive to perform with a general-purpose processor. In some embodiments, motion estimation engine 434 is generally available to graphics processor components to assist with video decode and processing functions that are sensitive or adaptive to the direction or magnitude of the motion within video data.

In some embodiments, image scaling and filtering module 436 performs image-processing operations to enhance the visual quality of generated images and video. In some embodiments, scaling and filtering module 436 processes image and video data during the sampling operation before providing the data to execution unit array 414.

In some embodiments, the GPE 410 includes a data port 444, which provides an additional mechanism for graphics subsystems to access memory. In some embodiments, data port 444 facilitates memory access for operations including render target writes, constant buffer reads, scratch memory space reads/writes, and media surface accesses. In some embodiments, data port 444 includes cache memory space to cache accesses to memory. The cache memory can be a single data cache or separated into multiple caches for the multiple subsystems that access memory via the data port (e.g., a render buffer cache, a constant buffer cache, etc.). In some embodiments, threads executing on an execution unit in execution unit array 414 communicate with the data port by exchanging messages via a data distribution interconnect that couples each of the sub-systems of GPE 410.

### Execution Units

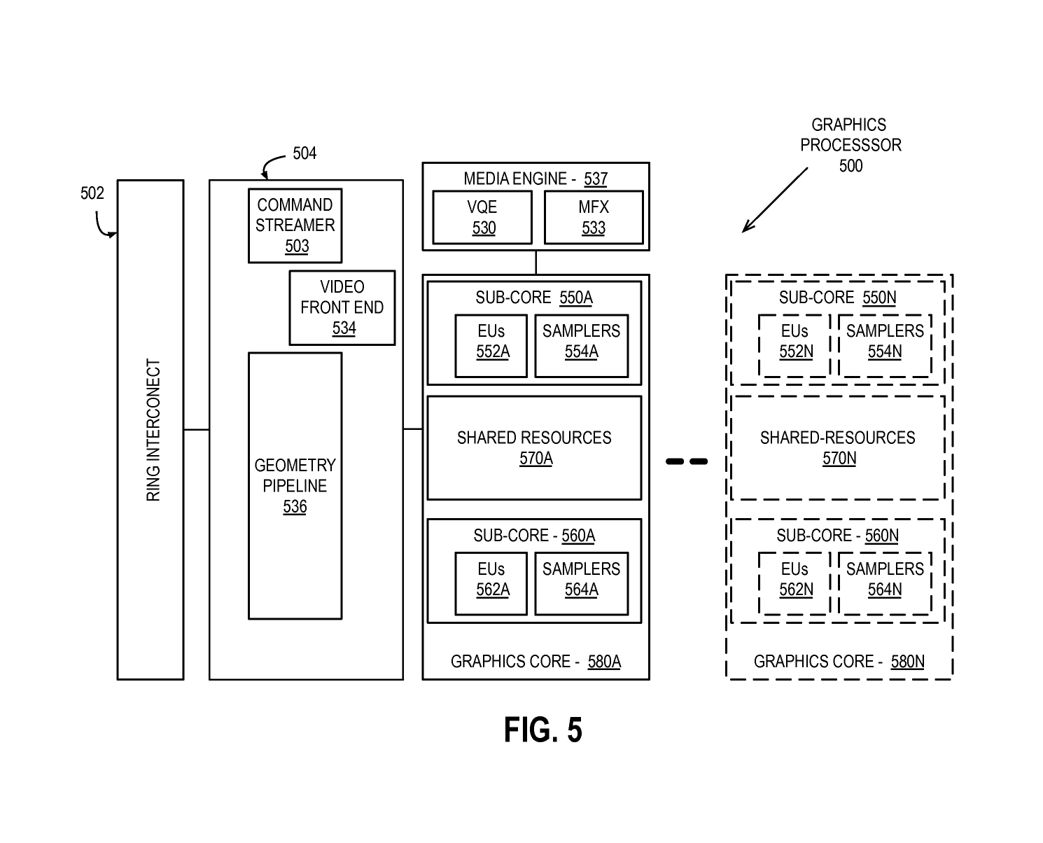

FIG. 5 is a block diagram of another embodiment of a graphics processor 500. Elements of FIG. 5 having the same reference numbers (or names) as the elements of any other figure herein can operate or function in any manner similar to that described elsewhere herein, but are not limited to such.

In some embodiments, graphics processor 500 includes a ring interconnect 502, a pipeline front-end 504, a media engine 537, and graphics cores 580A-580N. In some embodiments, ring interconnect 502 couples the graphics processor to other processing units, including other graphics processors or one or more general-purpose processor cores. In some embodiments, the graphics processor is one of many processors integrated within a multi-core processing system.

In some embodiments, graphics processor 500 receives batches of commands via ring interconnect 502. The incoming commands are interpreted by a command streamer 503 in the pipeline front-end 504. In some embodiments, graphics processor 500 includes scalable execution logic to perform 3D geometry processing and media processing via the graphics core(s) 580A-580N. For 3D geometry processing commands, command streamer 503 supplies commands to geometry pipeline 536. For at least some media processing commands, command streamer 503 supplies the commands to a video front end 534, which couples with a media engine 537. In some embodiments, media engine 537 includes a Video Quality Engine (VQE) 530 for video and image post-processing and a multi-format encode/decode (MFX) 533 engine to provide hardware-accelerated media data encode and decode. In some embodiments, geometry pipeline 536 and media engine 537 each generate execution threads for the thread execution resources provided by at least one graphics core 580A.

In some embodiments, graphics processor 500 includes scalable thread execution resources featuring modular cores 580A-580N (sometimes referred to as core slices), each having multiple sub-cores 550A-550N, 560A-560N (sometimes referred to as core sub-slices). In some embodiments, graphics processor 500 can have any number of graphics cores 580A through 580N. In some embodiments, graphics processor 500 includes a graphics core 580A having at least a first sub-core 550A and a second core sub-core 560A. In other embodiments, the graphics processor is a low power processor with a single sub-core (e.g., 550A). In some embodiments, graphics processor 500 includes multiple graphics cores 580A-580N, each including a set of first sub-cores 550A-550N and a set of second sub-cores 560A-560N. Each sub-core in the set of first sub-cores 550A-550N includes at least a first set of execution units 552A-552N and media/texture samplers 554A-554N. Each sub-core in the set of second sub-cores 560A-560N includes at least a second set of execution units 562A-562N and samplers 564A-564N. In some embodiments, each sub-core 550A-550N, 560A-560N shares a set of shared resources 570A-570N. In some embodiments, the shared resources include shared cache memory and pixel operation logic. Other shared resources may also be included in the various embodiments of the graphics processor.

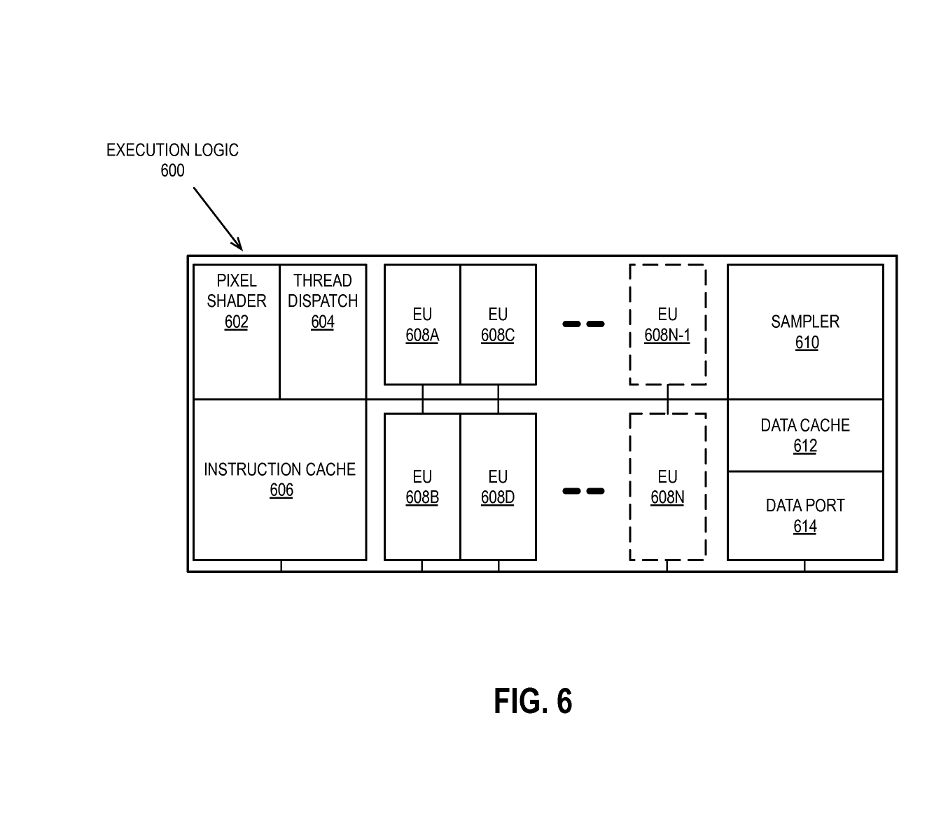

FIG. 6 illustrates thread execution logic 600 including an array of processing elements employed in some embodiments of a GPE. Elements of FIG. 6 having the same reference numbers (or names) as the elements of any other figure herein can operate or function in any manner similar to that described elsewhere herein, but are not limited to such.

In some embodiments, thread execution logic 600 includes a pixel shader 602, a thread dispatcher 604, instruction cache 606, a scalable execution unit array including a plurality of execution units 608A-608N, a sampler 610, a data cache 612, and a data port 614. In one embodiment the included components are interconnected via an interconnect fabric that links to each of the components. In some embodiments, thread execution logic 600 includes one or more connections to memory, such as system memory or cache memory, through one or more of instruction cache 606, data port 614, sampler 610, and execution unit array 608A-608N. In some embodiments, each execution unit (e.g. 608A) is an individual vector processor capable of executing multiple simultaneous threads and processing multiple data elements in parallel for each thread. In some embodiments, execution unit array 608A-608N includes any number individual execution units.

In some embodiments, execution unit array 608A-608N is primarily used to execute “shader” programs. In some embodiments, the execution units in array 608A-608N execute an instruction set that includes native support for many standard 3D graphics shader instructions, such that shader programs from graphics libraries (e.g., Direct 3D and OpenGL) are executed with a minimal translation. The execution units support vertex and geometry processing (e.g., vertex programs, geometry programs, vertex shaders), pixel processing (e.g., pixel shaders, fragment shaders) and general-purpose processing (e.g., compute and media shaders).

Each execution unit in execution unit array 608A-608N operates on arrays of data elements. The number of data elements is the “execution size,” or the number of channels for the instruction. An execution channel is a logical unit of execution for data element access, masking, and flow control within instructions. The number of channels may be independent of the number of physical Arithmetic Logic Units (ALUs) or Floating Point Units (FPUs) for a particular graphics processor. In some embodiments, execution units 608A-608N support integer and floating-point data types.

The execution unit instruction set includes single instruction multiple data (SIMD) instructions. The various data elements can be stored as a packed data type in a register and the execution unit will process the various elements based on the data size of the elements. For example, when operating on a 256-bit wide vector, the 256 bits of the vector are stored in a register and the execution unit operates on the vector as four separate 64-bit packed data elements (Quad-Word (QW) size data elements), eight separate 32-bit packed data elements (Double Word (DW) size data elements), sixteen separate 16-bit packed data elements (Word (W) size data elements), or thirty-two separate 8-bit data elements (byte (B) size data elements). However, different vector widths and register sizes are possible.

One or more internal instruction caches (e.g., 606) are included in the thread execution logic 600 to cache thread instructions for the execution units. In some embodiments, one or more data caches (e.g., 612) are included to cache thread data during thread execution. In some embodiments, sampler 610 is included to provide texture sampling for 3D operations and media sampling for media operations. In some embodiments, sampler 610 includes specialized texture or media sampling functionality to process texture or media data during the sampling process before providing the sampled data to an execution unit.

During execution, the graphics and media pipelines send thread initiation requests to thread execution logic 600 via thread spawning and dispatch logic. In some embodiments, thread execution logic 600 includes a local thread dispatcher 604 that arbitrates thread initiation requests from the graphics and media pipelines and instantiates the requested threads on one or more execution units 608A-608N. For example, the geometry pipeline (e.g., 536 of FIG. 5) dispatches vertex processing, tessellation, or geometry processing threads to thread execution logic 600 (FIG. 6). In some embodiments, thread dispatcher 604 can also process runtime thread spawning requests from the executing shader programs.

Once a group of geometric objects has been processed and rasterized into pixel data, pixel shader 602 is invoked to further compute output information and cause results to be written to output surfaces (e.g., color buffers, depth buffers, stencil buffers, etc.). In some embodiments, pixel shader 602 calculates the values of the various vertex attributes that are to be interpolated across the rasterized object. In some embodiments, pixel shader 602 then executes an application programming interface (API)-supplied pixel shader program. To execute the pixel shader program, pixel shader 602 dispatches threads to an execution unit (e.g., 608A) via thread dispatcher 604. In some embodiments, pixel shader 602 uses texture sampling logic in sampler 610 to access texture data in texture maps stored in memory. Arithmetic operations on the texture data and the input geometry data compute pixel color data for each geometric fragment, or discards one or more pixels from further processing.

In some embodiments, the data port 614 provides a memory access mechanism for the thread execution logic 600 output processed data to memory for processing on a graphics processor output pipeline. In some embodiments, the data port 614 includes or couples to one or more cache memories (e.g., data cache 612) to cache data for memory access via the data port.

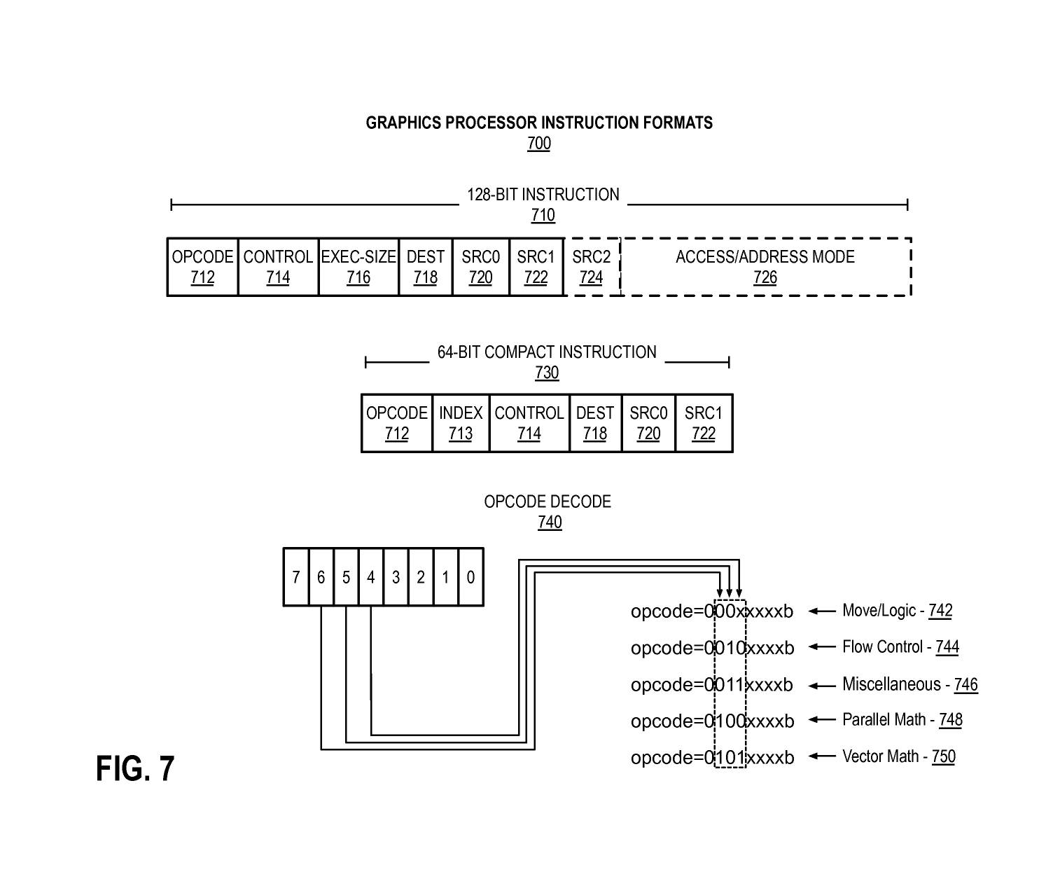

FIG. 7 is a block diagram illustrating a graphics processor instruction formats 700 according to some embodiments. In one or more embodiment, the graphics processor execution units support an instruction set having instructions in multiple formats. The solid lined boxes illustrate the components that are generally included in an execution unit instruction, while the dashed lines include components that are optional or that are only included in a sub-set of the instructions. In some embodiments, instruction format 700 described and illustrated are macro-instructions, in that they are instructions supplied to the execution unit, as opposed to micro-operations resulting from instruction decode once the instruction is processed.

In some embodiments, the graphics processor execution units natively support instructions in a 128-bit format 710. A 64-bit compacted instruction format 730 is available for some instructions based on the selected instruction, instruction options, and number of operands. The native 128-bit format 710 provides access to all instruction options, while some options and operations are restricted in the 64-bit format 730. The native instructions available in the 64-bit format 730 vary by embodiment. In some embodiments, the instruction is compacted in part using a set of index values in an index field 713. The execution unit hardware references a set of compaction tables based on the index values and uses the compaction table outputs to reconstruct a native instruction in the 128-bit format 710.

For each format, instruction opcode 712 defines the operation that the execution unit is to perform. The execution units execute each instruction in parallel across the multiple data elements of each operand. For example, in response to an add instruction the execution unit performs a simultaneous add operation across each color channel representing a texture element or picture element. By default, the execution unit performs each instruction across all data channels of the operands. In some embodiments, instruction control field 714 enables control over certain execution options, such as channels selection (e.g., predication) and data channel order (e.g., swizzle). For 128-bit instructions 710 an exec-size field 716 limits the number of data channels that will be executed in parallel. In some embodiments, exec-size field 716 is not available for use in the 64-bit compact instruction format 730.

Some execution unit instructions have up to three operands including two source operands, src0 720, src1 722, and one destination 718. In some embodiments, the execution units support dual destination instructions, where one of the destinations is implied. Data manipulation instructions can have a third source operand (e.g., SRC2 724), where the instruction opcode 712 determines the number of source operands. An instruction's last source operand can be an immediate (e.g., hard-coded) value passed with the instruction.

In some embodiments, the 128-bit instruction format 710 includes an access/address mode information 726 specifying, for example, whether direct register addressing mode or indirect register addressing mode is used. When direct register addressing mode is used, the register address of one or more operands is directly provided by bits in the instruction 710.

In some embodiments, the 128-bit instruction format 710 includes an access/address mode field 726, which specifies an address mode and/or an access mode for the instruction. In one embodiment the access mode to define a data access alignment for the instruction. Some embodiments support access modes including a 16-byte aligned access mode and a 1-byte aligned access mode, where the byte alignment of the access mode determines the access alignment of the instruction operands. For example, when in a first mode, the instruction 710 may use byte-aligned addressing for source and destination operands and when in a second mode, the instruction 710 may use 16-byte-aligned addressing for all source and destination operands.

In one embodiment, the address mode portion of the access/address mode field 726 determines whether the instruction is to use direct or indirect addressing. When direct register addressing mode is used bits in the instruction 710 directly provide the register address of one or more operands. When indirect register addressing mode is used, the register address of one or more operands may be computed based on an address register value and an address immediate field in the instruction.

In some embodiments instructions are grouped based on opcode 712 bit-fields to simplify Opcode decode 740. For an 8-bit opcode, bits 4, 5, and 6 allow the execution unit to determine the type of opcode. The precise opcode grouping shown is merely an example. In some embodiments, a move and logic opcode group 742 includes data movement and logic instructions (e.g., move (mov), compare (cmp)). In some embodiments, move and logic group 742 shares the five most significant bits (MSB), where move (mov) instructions are in the form of 0000xxxxb and logic instructions are in the form of 0001xxxxb. A flow control instruction group 744 (e.g., call, jump (jmp)) includes instructions in the form of 0010xxxxb (e.g., 0x20). A miscellaneous instruction group 746 includes a mix of instructions, including synchronization instructions (e.g., wait, send) in the form of 0011xxxxb (e.g., 0x30). A parallel math instruction group 748 includes component-wise arithmetic instructions (e.g., add, multiply (mul)) in the form of 0100xxxxb (e.g., 0x40). The parallel math group 748 performs the arithmetic operations in parallel across data channels. The vector math group 750 includes arithmetic instructions (e.g., dp4) in the form of 0101xxxxb (e.g., 0x50). The vector math group performs arithmetic such as dot product calculations on vector operands.

### Graphics Pipeline

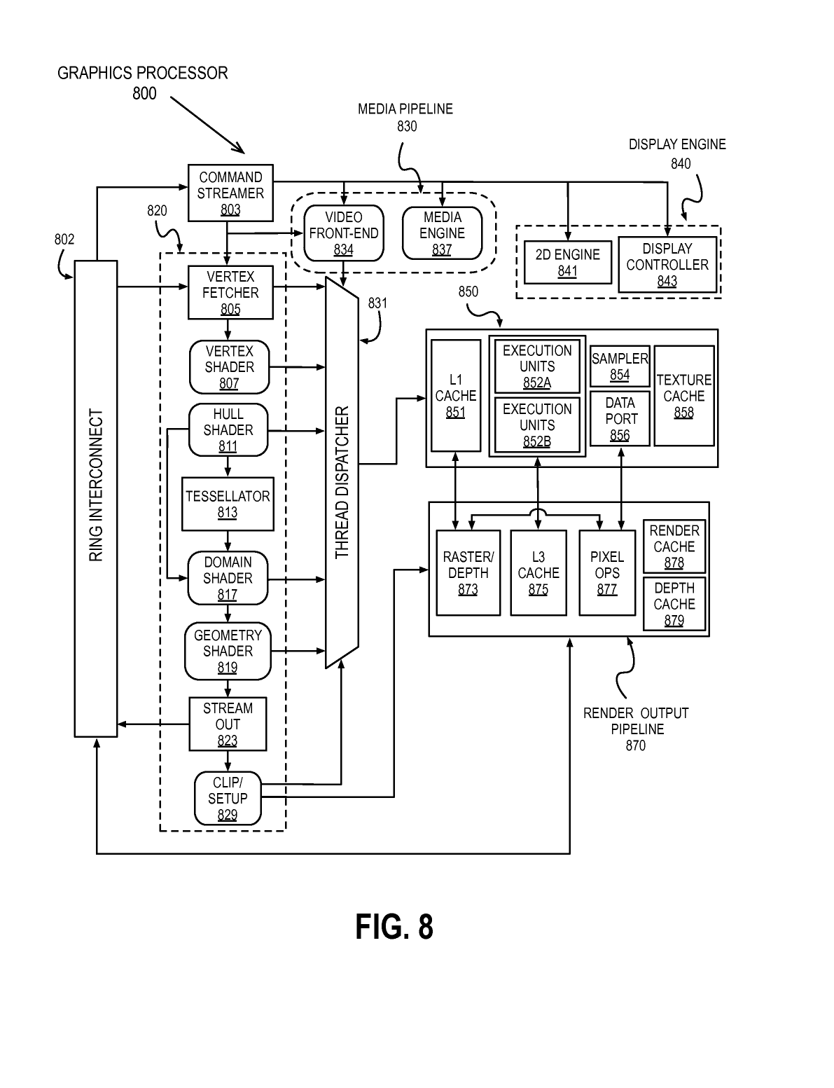

FIG. 8 is a block diagram of another embodiment of a graphics processor 800. Elements of FIG. 8 having the same reference numbers (or names) as the elements of any other figure herein can operate or function in any manner similar to that described elsewhere herein, but are not limited to such.

In some embodiments, graphics processor 800 includes a graphics pipeline 820, a media pipeline 830, a display engine 840, thread execution logic 850, and a render output pipeline 870. In some embodiments, graphics processor 800 is a graphics processor within a multi-core processing system that includes one or more general-purpose processing cores. The graphics processor is controlled by register writes to one or more control registers (not shown) or via commands issued to graphics processor 800 via a ring interconnect 802. In some embodiments, ring interconnect 802 couples graphics processor 800 to other processing components, such as other graphics processors or general-purpose processors. Commands from ring interconnect 802 are interpreted by a command streamer 803, which supplies instructions to individual components of graphics pipeline 820 or media pipeline 830.

In some embodiments, command streamer 803 directs the operation of a vertex fetcher 805 that reads vertex data from memory and executes vertex-processing commands provided by command streamer 803. In some embodiments, vertex fetcher 805 provides vertex data to a vertex shader 807, which performs coordinate space transformation and lighting operations to each vertex. In some embodiments, vertex fetcher 805 and vertex shader 807 execute vertex-processing instructions by dispatching execution threads to execution units 852A, 852B via a thread dispatcher 831.

In some embodiments, execution units 852A, 852B are an array of vector processors having an instruction set for performing graphics and media operations. In some embodiments, execution units 852A, 852B have an attached L1 cache 851 that is specific for each array or shared between the arrays. The cache can be configured as a data cache, an instruction cache, or a single cache that is partitioned to contain data and instructions in different partitions.

In some embodiments, graphics pipeline 820 includes tessellation components to perform hardware-accelerated tessellation of 3D objects. In some embodiments, a programmable hull shader 811 configures the tessellation operations. A programmable domain shader 817 provides back-end evaluation of tessellation output. A tessellator 813 operates at the direction of hull shader 811 and contains special purpose logic to generate a set of detailed geometric objects based on a coarse geometric model that is provided as input to graphics pipeline 820. In some embodiments, if tessellation is not used, tessellation components 811, 813, 817 can be bypassed.

In some embodiments, complete geometric objects can be processed by a geometry shader 819 via one or more threads dispatched to execution units 852A, 852B, or can proceed directly to the clipper 829. In some embodiments, the geometry shader operates on entire geometric objects, rather than vertices or patches of vertices as in previous stages of the graphics pipeline. If the tessellation is disabled the geometry shader 819 receives input from the vertex shader 807. In some embodiments, geometry shader 819 is programmable by a geometry shader program to perform geometry tessellation if the tessellation units are disabled.

Before rasterization, a clipper 829 processes vertex data. The clipper 829 may be a fixed function clipper or a programmable clipper having clipping and geometry shader functions. In some embodiments, a rasterizer and depth test component 873 in the render output pipeline 870 dispatches pixel shaders to convert the geometric objects into their per pixel representations. In some embodiments, pixel shader logic is included in thread execution logic 850. In some embodiments, an application can bypass the rasterizer 873 and access un-rasterized vertex data via a stream out unit 823.

The graphics processor 800 has an interconnect bus, interconnect fabric, or some other interconnect mechanism that allows data and message passing amongst the major components of the processor. In some embodiments, execution units 852A, 852B and associated cache(s) 851, texture and media sampler 854, and texture/sampler cache 858 interconnect via a data port 856 to perform memory access and communicate with render output pipeline components of the processor. In some embodiments, sampler 854, caches 851, 858 and execution units 852A, 852B each have separate memory access paths.

In some embodiments, render output pipeline 870 contains a rasterizer and depth test component 873 that converts vertex-based objects into an associated pixel-based representation. In some embodiments, the rasterizer logic includes a windower/masker unit to perform fixed function triangle and line rasterization. An associated render cache 878 and depth cache 879 are also available in some embodiments. A pixel operations component 877 performs pixel-based operations on the data, though in some instances, pixel operations associated with 2D operations (e.g. bit block image transfers with blending) are performed by the 2D engine 841, or substituted at display time by the display controller 843 using overlay display planes. In some embodiments, a shared L3 cache 875 is available to all graphics components, allowing the sharing of data without the use of main system memory.

In some embodiments, graphics processor media pipeline 830 includes a media engine 837 and a video front end 834. In some embodiments, video front end 834 receives pipeline commands from the command streamer 803. In some embodiments, media pipeline 830 includes a separate command streamer. In some embodiments, video front-end 834 processes media commands before sending the command to the media engine 837. In some embodiments, media engine 837 includes thread spawning functionality to spawn threads for dispatch to thread execution logic 850 via thread dispatcher 831.

In some embodiments, graphics processor 800 includes a display engine 840. In some embodiments, display engine 840 is external to processor 800 and couples with the graphics processor via the ring interconnect 802, or some other interconnect bus or fabric. In some embodiments, display engine 840 includes a 2D engine 841 and a display controller 843. In some embodiments, display engine 840 contains special purpose logic capable of operating independently of the 3D pipeline. In some embodiments, display controller 843 couples with a display device (not shown), which may be a system integrated display device, as in a laptop computer, or an external display device attached via a display device connector.

In some embodiments, graphics pipeline 820 and media pipeline 830 are configurable to perform operations based on multiple graphics and media programming interfaces and are not specific to any one application programming interface (API). In some embodiments, driver software for the graphics processor translates API calls that are specific to a particular graphics or media library into commands that can be processed by the graphics processor. In some embodiments, support is provided for the Open Graphics Library (OpenGL) and Open Computing Language (OpenCL) from the Khronos Group, the Direct3D library from the Microsoft Corporation, or support may be provided to both OpenGL and D3D. Support may also be provided for the Open Source Computer Vision Library (OpenCV). A future API with a compatible 3D pipeline would also be supported if a mapping can be made from the pipeline of the future API to the pipeline of the graphics processor.

### Graphics Pipeline Programming

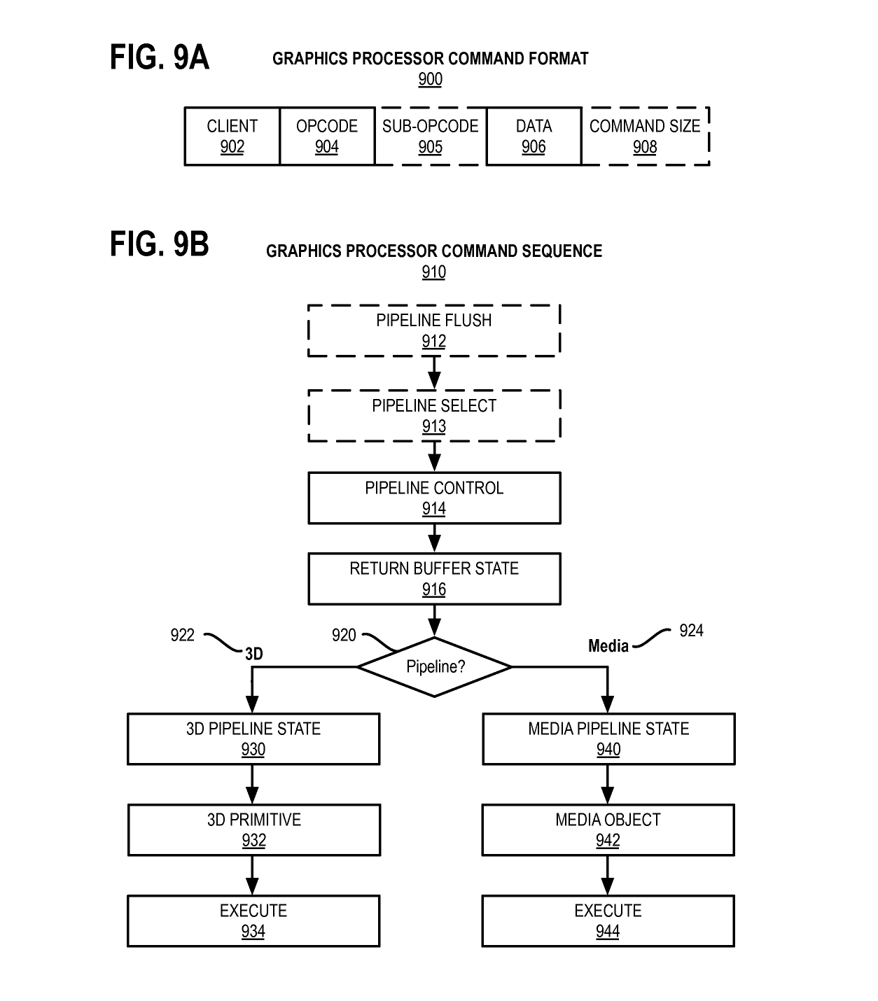

FIG. 9A is a block diagram illustrating a graphics processor command format 900 according to some embodiments. FIG. 9B is a block diagram illustrating a graphics processor command sequence 910 according to an embodiment. The solid lined boxes in FIG. 9A illustrate the components that are generally included in a graphics command while the dashed lines include components that are optional or that are only included in a sub-set of the graphics commands. The exemplary graphics processor command format 900 of FIG. 9A includes data fields to identify a target client 902 of the command, a command operation code (opcode) 904, and the relevant data 906 for the command. A sub-opcode 905 and a command size 908 are also included in some commands.

In some embodiments, client 902 specifies the client unit of the graphics device that processes the command data. In some embodiments, a graphics processor command parser examines the client field of each command to condition the further processing of the command and route the command data to the appropriate client unit. In some embodiments, the graphics processor client units include a memory interface unit, a render unit, a 2D unit, a 3D unit, and a media unit. Each client unit has a corresponding processing pipeline that processes the commands. Once the command is received by the client unit, the client unit reads the opcode 904 and, if present, sub-opcode 905 to determine the operation to perform. The client unit performs the command using information in data field 906. For some commands an explicit command size 908 is expected to specify the size of the command. In some embodiments, the command parser automatically determines the size of at least some of the commands based on the command opcode. In some embodiments commands are aligned via multiples of a double word.

The flow diagram in FIG. 9B shows an exemplary graphics processor command sequence 910. In some embodiments, software or firmware of a data processing system that features an embodiment of a graphics processor uses a version of the command sequence shown to set up, execute, and terminate a set of graphics operations. A sample command sequence is shown and described for purposes of example only as embodiments are not limited to these specific commands or to this command sequence. Moreover, the commands may be issued as batch of commands in a command sequence, such that the graphics processor will process the sequence of commands in at least partially concurrence.

In some embodiments, the graphics processor command sequence 910 may begin with a pipeline flush command 912 to cause any active graphics pipeline to complete the currently pending commands for the pipeline. In some embodiments, the 3D pipeline 922 and the media pipeline 924 do not operate concurrently. The pipeline flush is performed to cause the active graphics pipeline to complete any pending commands. In response to a pipeline flush, the command parser for the graphics processor will pause command processing until the active drawing engines complete pending operations and the relevant read caches are invalidated. Optionally, any data in the render cache that is marked ‘dirty’ can be flushed to memory. In some embodiments, pipeline flush command 912 can be used for pipeline synchronization or before placing the graphics processor into a low power state.

In some embodiments, a pipeline select command 913 is used when a command sequence requires the graphics processor to explicitly switch between pipelines. In some embodiments, a pipeline select command 913 is required only once within an execution context before issuing pipeline commands unless the context is to issue commands for both pipelines. In some embodiments, a pipeline flush command is 912 is required immediately before a pipeline switch via the pipeline select command 913.

In some embodiments, a pipeline control command 914 configures a graphics pipeline for operation and is used to program the 3D pipeline 922 and the media pipeline 924. In some embodiments, pipeline control command 914 configures the pipeline state for the active pipeline. In one embodiment, the pipeline control command 914 is used for pipeline synchronization and to clear data from one or more cache memories within the active pipeline before processing a batch of commands.

In some embodiments, return buffer state commands 916 are used to configure a set of return buffers for the respective pipelines to write data. Some pipeline operations require the allocation, selection, or configuration of one or more return buffers into which the operations write intermediate data during processing. In some embodiments, the graphics processor also uses one or more return buffers to store output data and to perform cross thread communication. In some embodiments, the return buffer state 916 includes selecting the size and number of return buffers to use for a set of pipeline operations.

The remaining commands in the command sequence differ based on the active pipeline for operations. Based on a pipeline determination 920, the command sequence is tailored to the 3D pipeline 922 beginning with the 3D pipeline state 930, or the media pipeline 924 beginning at the media pipeline state 940.

The commands for the 3D pipeline state 930 include 3D state setting commands for vertex buffer state, vertex element state, constant color state, depth buffer state, and other state variables that are to be configured before 3D primitive commands are processed. The values of these commands are determined at least in part based the particular 3D API in use. In some embodiments, 3D pipeline state 930 commands are also able to selectively disable or bypass certain pipeline elements if those elements will not be used.

In some embodiments, 3D primitive 932 command is used to submit 3D primitives to be processed by the 3D pipeline. Commands and associated parameters that are passed to the graphics processor via the 3D primitive 932 command are forwarded to the vertex fetch function in the graphics pipeline. The vertex fetch function uses the 3D primitive 932 command data to generate vertex data structures. The vertex data structures are stored in one or more return buffers. In some embodiments, 3D primitive 932 command is used to perform vertex operations on 3D primitives via vertex shaders. To process vertex shaders, 3D pipeline 922 dispatches shader execution threads to graphics processor execution units.

In some embodiments, 3D pipeline 922 is triggered via an execute 934 command or event. In some embodiments, a register write triggers command execution. In some embodiments execution is triggered via a ‘go’ or ‘kick’ command in the command sequence. In one embodiment command execution is triggered using a pipeline synchronization command to flush the command sequence through the graphics pipeline. The 3D pipeline will perform geometry processing for the 3D primitives. Once operations are complete, the resulting geometric objects are rasterized and the pixel engine colors the resulting pixels. Additional commands to control pixel shading and pixel back end operations may also be included for those operations.

In some embodiments, the graphics processor command sequence 910 follows the media pipeline 924 path when performing media operations. In general, the specific use and manner of programming for the media pipeline 924 depends on the media or compute operations to be performed. Specific media decode operations may be offloaded to the media pipeline during media decode. In some embodiments, the media pipeline can also be bypassed and media decode can be performed in whole or in part using resources provided by one or more general-purpose processing cores. In one embodiment, the media pipeline also includes elements for general-purpose graphics processor unit (GPGPU) operations, where the graphics processor is used to perform SIMD vector operations using computational shader programs that are not explicitly related to the rendering of graphics primitives.

In some embodiments, media pipeline 924 is configured in a similar manner as the 3D pipeline 922. A set of media pipeline state commands 940 are dispatched or placed into in a command queue before the media object commands 942. In some embodiments, media pipeline state commands 940 include data to configure the media pipeline elements that will be used to process the media objects. This includes data to configure the video decode and video encode logic within the media pipeline, such as encode or decode format. In some embodiments, media pipeline state commands 940 also support the use one or more pointers to “indirect” state elements that contain a batch of state settings.

In some embodiments, media object commands 942 supply pointers to media objects for processing by the media pipeline. The media objects include memory buffers containing video data to be processed. In some embodiments, all media pipeline states must be valid before issuing a media object command 942. Once the pipeline state is configured and media object commands 942 are queued, the media pipeline 924 is triggered via an execute command 944 or an equivalent execute event (e.g., register write). Output from media pipeline 924 may then be post processed by operations provided by the 3D pipeline 922 or the media pipeline 924. In some embodiments, GPGPU operations are configured and executed in a similar manner as media operations.

### Graphics Software Architecture

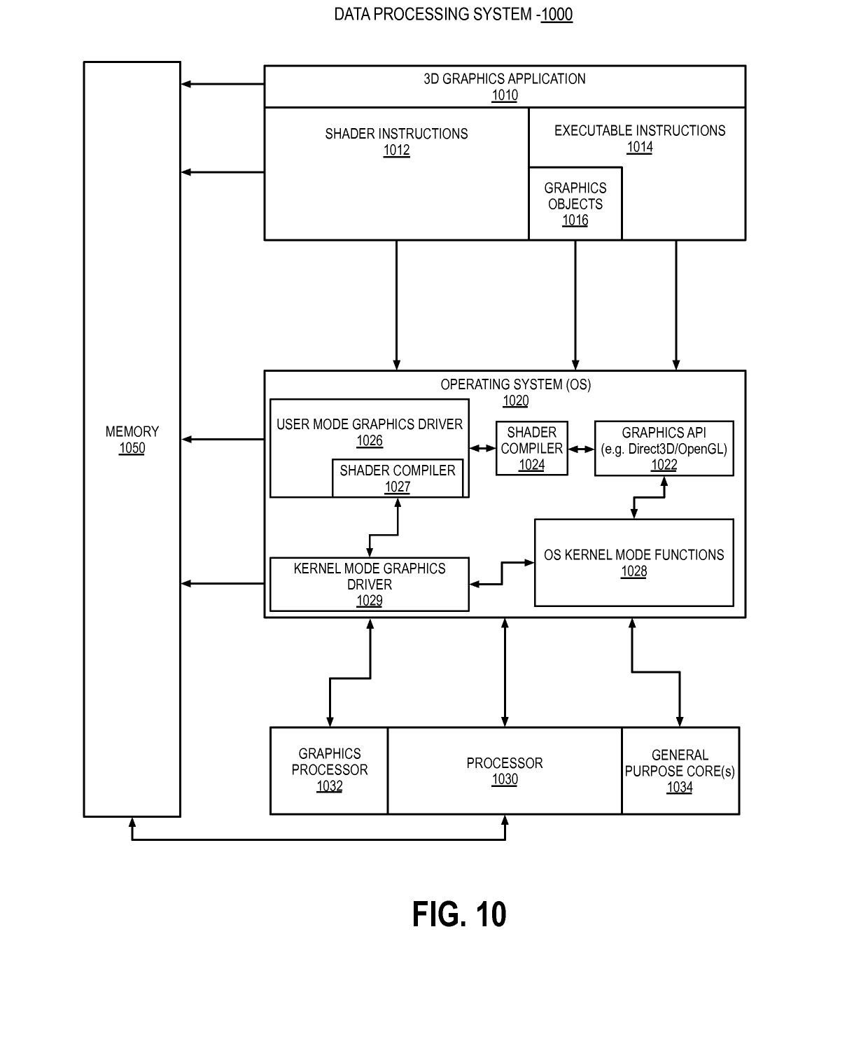

FIG. 10 illustrates exemplary graphics software architecture for a data processing system 1000 according to some embodiments. In some embodiments, software architecture includes a 3D graphics application 1010, an operating system 1020, and at least one processor 1030. In some embodiments, processor 1030 includes a graphics processor 1032 and one or more general-purpose processor core(s) 1034. The graphics application 1010 and operating system 1020 each execute in the system memory 1050 of the data processing system.

In some embodiments, 3D graphics application 1010 contains one or more shader programs including shader instructions 1012. The shader language instructions may be in a high-level shader language, such as the High Level Shader Language (HLSL) or the OpenGL Shader Language (GLSL). The application also includes executable instructions 1014 in a machine language suitable for execution by the general-purpose processor core 1034. The application also includes graphics objects 1016 defined by vertex data.

In some embodiments, operating system 1020 is a Microsoft® Windows® operating system from the Microsoft Corporation, a proprietary UNIX-like operating system, or an open source UNIX-like operating system using a variant of the Linux kernel. When the Direct3D API is in use, the operating system 1020 uses a front-end shader compiler 1024 to compile any shader instructions 1012 in HLSL into a lower-level shader language. The compilation may be a just-in-time (JIT) compilation or the application can perform shader pre-compilation. In some embodiments, high-level shaders are compiled into low-level shaders during the compilation of the 3D graphics application 1010.

In some embodiments, user mode graphics driver 1026 contains a back-end shader compiler 1027 to convert the shader instructions 1012 into a hardware specific representation. When the OpenGL API is in use, shader instructions 1012 in the GLSL high-level language are passed to a user mode graphics driver 1026 for compilation. In some embodiments, user mode graphics driver 1026 uses operating system kernel mode functions 1028 to communicate with a kernel mode graphics driver 1029. In some embodiments, kernel mode graphics driver 1029 communicates with graphics processor 1032 to dispatch commands and instructions.

### IP Core Implementations

One or more aspects of at least one embodiment may be implemented by representative code stored on a machine-readable medium which represents and/or defines logic within an integrated circuit such as a processor. For example, the machine-readable medium may include instructions which represent various logic within the processor. When read by a machine, the instructions may cause the machine to fabricate the logic to perform the techniques described herein. Such representations, known as “IP cores,” are reusable units of logic for an integrated circuit that may be stored on a tangible, machine-readable medium as a hardware model that describes the structure of the integrated circuit. The hardware model may be supplied to various customers or manufacturing facilities, which load the hardware model on fabrication machines that manufacture the integrated circuit. The integrated circuit may be fabricated such that the circuit performs operations described in association with any of the embodiments described herein.

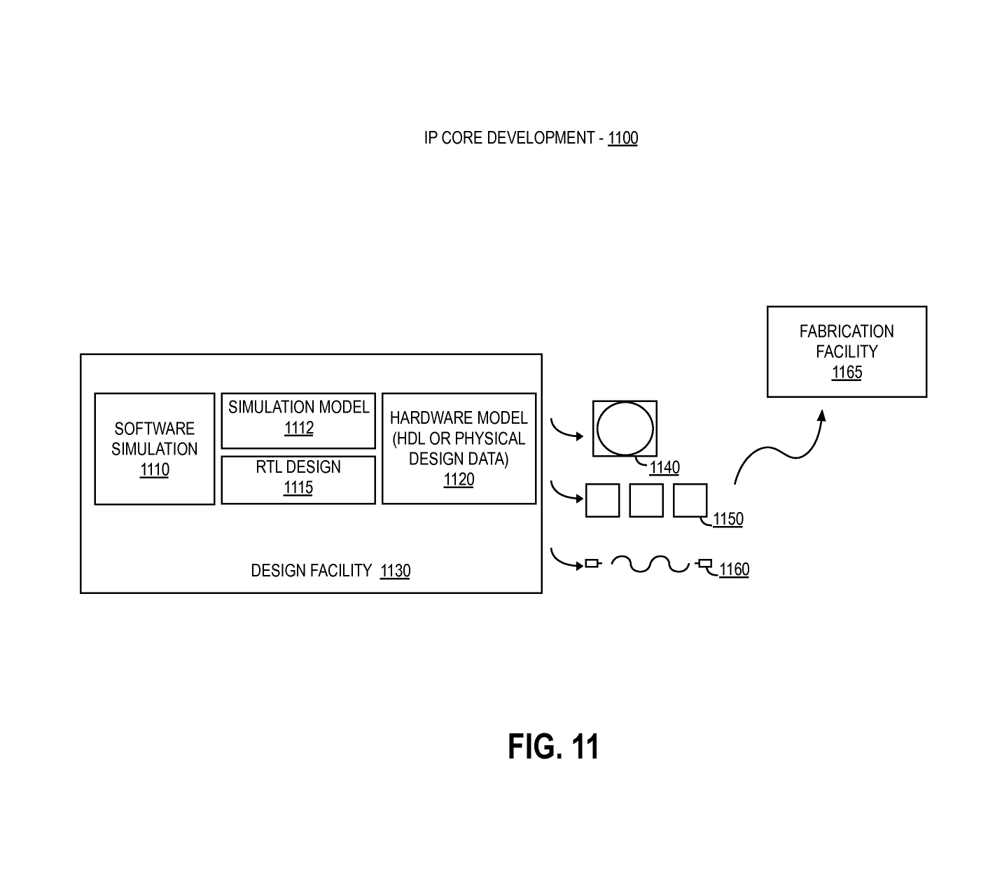

FIG. 11 is a block diagram illustrating an IP core development system 1100 that may be used to manufacture an integrated circuit to perform operations according to an embodiment. The IP core development system 1100 may be used to generate modular, re-usable designs that can be incorporated into a larger design or used to construct an entire integrated circuit (e.g., an SOC integrated circuit). A design facility 1130 can generate a software simulation 1110 of an IP core design in a high level programming language (e.g., C/C++). The software simulation 1110 can be used to design, test, and verify the behavior of the IP core. A register transfer level (RTL) design can then be created or synthesized from the simulation model 1112. The RTL design 1115 is an abstraction of the behavior of the integrated circuit that models the flow of digital signals between hardware registers, including the associated logic performed using the modeled digital signals. In addition to an RTL design 1115, lower-level designs at the logic level or transistor level may also be created, designed, or synthesized. Thus, the particular details of the initial design and simulation may vary.

The RTL design 1115 or equivalent may be further synthesized by the design facility into a hardware model 1120, which may be in a hardware description language (HDL), or some other representation of physical design data. The HDL may be further simulated or tested to verify the IP core design. The IP core design can be stored for delivery to a 3^{rd} party fabrication facility 1165 using non-volatile memory 1140 (e.g., hard disk, flash memory, or any non-volatile storage medium). Alternatively, the IP core design may be transmitted (e.g., via the Internet) over a wired connection 1150 or wireless connection 1160. The fabrication facility 1165 may then fabricate an integrated circuit that is based at least in part on the IP core design. The fabricated integrated circuit can be configured to perform operations in accordance with at least one embodiment described herein.

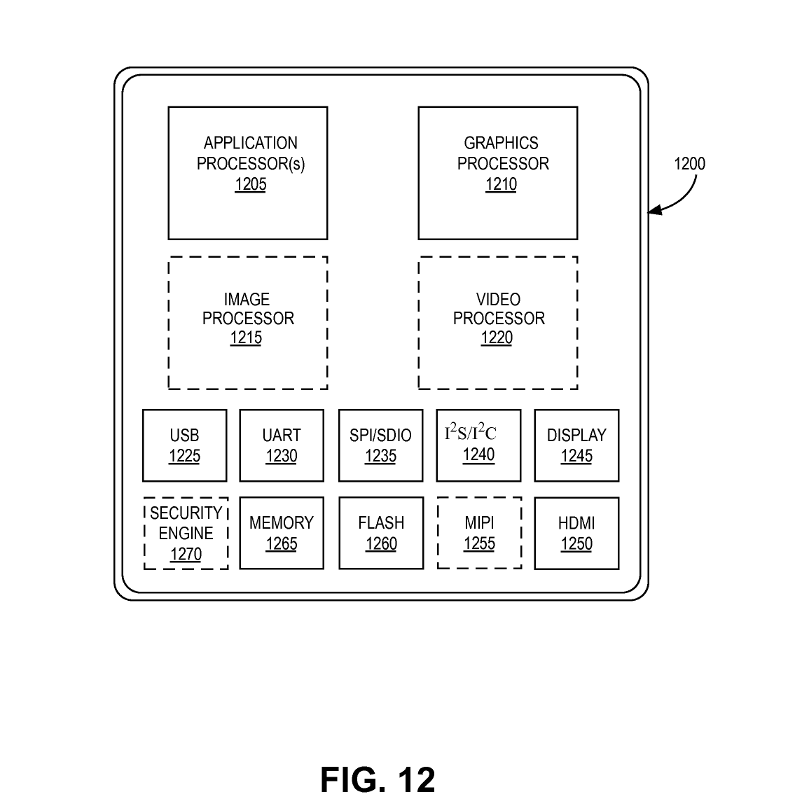

FIG. 12 is a block diagram illustrating an exemplary system on a chip integrated circuit 1200 that may be fabricated using one or more IP cores, according to an embodiment. The exemplary integrated circuit includes one or more application processors 1205 (e.g., CPUs), at least one graphics processor 1210, and may additionally include an image processor 1215 and/or a video processor 1220, any of which may be a modular IP core from the same or multiple different design facilities. The integrated circuit includes peripheral or bus logic including a USB controller 1225, UART controller 1230, an SPI/SDIO controller 1235, and an I²S/I²C controller 1240. Additionally, the integrated circuit can include a display device 1245 coupled to one or more of a high-definition multimedia interface (HDMI) controller 1250 and a mobile industry processor interface (MIPI) display interface 1255. Storage may be provided by a flash memory subsystem 1260 including flash memory and a flash memory controller. Memory interface may be provided via a memory controller 1265 for access to SDRAM or SRAM memory devices. Some integrated circuits additionally include an embedded security engine 1270.

Additionally, other logic and circuits may be included in the processor of integrated circuit 1200, including additional graphics processors/cores, peripheral interface controllers, or general-purpose processor cores.

### Programmable Per Pixel Sample Placement Using Conservative Rasterization

One embodiment provides for programmable per pixel sample placement using a conservative rasterizer. The conservative rasterizer rasterizes any pixel where the pixel coverage could have non-zero coverage even though the triangle may not cover any discrete visibility sample in that pixel. Post-clipping edge equations for a triangle are passed to the pixel shader, enabling a developer to programmatically position samples anywhere within the pixel. The developer can then use the placed samples to perform a programmatic “in-out” test for the triangle edges using pixel sharing hardware. If the sample(s) are found to be inside the triangle, the developer uses the pull mode interpolation followed by the shading calculations at that sample location(s). Otherwise, if the desired sample is found to be outside of the triangle, user simply discards the pixel. As a result of the discard, an early depth/stencil test cannot be performed. Also as the specific sample location at which the early depth/stencil test is to be performed is not known until sample placement is performed inside of the pixel shader, an early depth-stencil test wouldn't have been meaningful even without the discard.

While samples may be placed at any position within a pixel and can vary from pixel to pixel, the sample placement is consistent at a given pixel on the screen from a given perspective (camera location). In other words, samples are consistently and repeatedly positioned for a given pixel on the screen within a frame. The consistent positioning enables depth and stencil tests to be performed at the same sample location for a given pixel on the screen from a given perspective (camera location). Additionally, where multiple samples per pixel are in use, each sample will be positioned at the same location for all occurrences of the sample within the frame, and for a given viewpoint within the frame. For example, light viewpoint sample position may differ from camera viewpoint ample positions within a single frame.

Although sample positions may vary between frames, pixel shader logic that exploits inter-frame coherence should preserve sample locations across frames. Additionally, where samples are non-uniformly spaced, finite difference derivatives can be calculated programmatically and provided to the texture sampler for use during the sharing process.

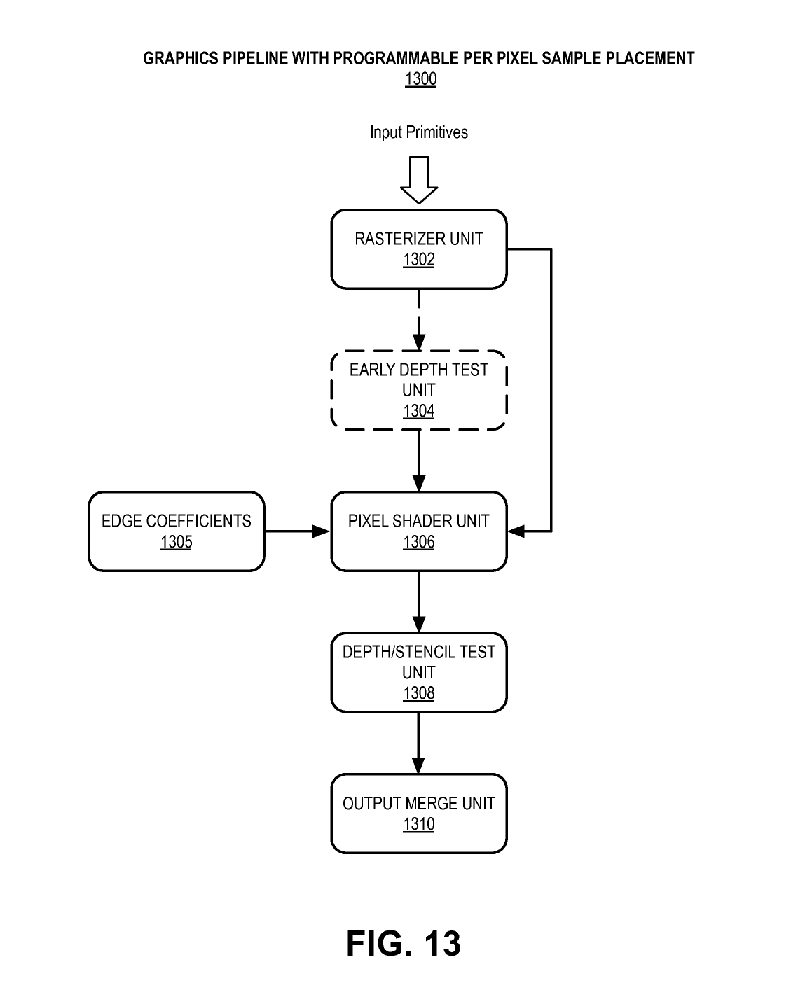

FIG. 13 is a block diagram of a graphics pipeline 1300 with programmable per pixel sample placement, according to an embodiment. In one embodiment the graphics pipeline 1300 includes a rasterization unit 1302, and early depth test unit 1304, a pixel shader unit 1306, a depth/stencil test unit 1308, and an output merge unit 1310. The rasterization unit 1302 can be configured to convert 3D geometric primitives such as rectangles, triangles, lines, etc., into fragments using one of several available rasterization algorithms. In one embodiment, the conservative rasterization algorithm is used. The early depth test unit 1304 can be used to process fragments output by the rasterization unit 1302. However, when programmable pixel placement is enabled the early depth test unit 1304 can no longer be used, as the early depth test cannot be performed until sample placement is performed inside of the pixel shader. The pixel shader unit 1306 generates pixels based the input fragments and the resulting pixels can be sent to a depth/stencil test unit 1308 before being sent to the output merge unit 1310.

In general, pipeline operations when programmable per pixel sample placement is enabled are as follows. First, the rasterization mode of the rasterizer unit 1302 is configured. In one embodiment, conservative rasterization is used and the rasterizer unit 1302 is set to conservative rasterization mode. Next, the graphics pipeline 1300 generates post-clipping edge coefficients 1305 for the three edges of the coverage triangle and passes the edge coefficients to the pixel shader unit 1306. The graphics pipeline 1300 can pass the edge coefficients to the pixel shader unit 1306 as an array of floating point data.

In one embodiment the edge coefficients 1305 used for the coverage test are based on line coefficients L₀, Lₓ, and L_{y} for each edge of the triangle. The L₀ value of an edge of a triangle is based on a measure of distance to the edge from a reference point. For an edge having a vertex coordinate (Xᵥₑᵣₜₑₓ, Yᵥₑᵣₜₑₓ), the L₀ to a reference point having coordinates (X_{ref}, Y_{ref}) is defined as:

L₀=Lₓ×(X_{ref}−Xᵥₑᵣₜₑₓ)+L_{y}×(Y_{ref}−Yᵥₑᵣₜₑₓ)

Where, for each edge:

$${L}_{x} = \frac{- Δ Y}{Δ X + Δ Y} and {L}_{y} = \frac{Δ X}{Δ X + Δ Y}$$

The above equations apply for screen spaces having an origin in the upper left hand corner and should be adjusted accordingly for screen spaces having a different origin. ΔY and ΔX for an edge is defined as the absolute value of the differences in the Y and X coordinates for each edge. Lₓ and L_{y} generally describe the change in distance with respect to x and y directions. Lₓ describes the change in distance in the x direction from one pixel to the next pixel along an edge. L_{y} describes the change in distance in the y direction from one pixel to the next pixel along an edge. A rasterizer can determine the distance using a perpendicular (e.g., Euclidian) distance, a Manhattan (e.g., rectilinear) approximation of the distance, or some other well-known distance metric. The edge coefficient values are planar values, such that the distance to the edge can be calculated for any pixel on the screen by adding or subtracting multiples of Lₓ and/or L_{y}.

In one embodiment, a pixel mask to determine the set of pixels to be shaded can be is determined by solving the line equations at the pixel centers for the three edges of the triangle, where the line equation for each edge is defined as:

L₀+(L_{y}×X)+(Lₓ×Y)

A positive answer for all edges indicates a pixel is inside the polygon; a negative answer from any of the edge indicates the pixel is outside the polygon.

Once the edge coefficients 1305 are supplied to the pixel shader unit 1306, the pixel shader unit 1306 executes developer supplied shader instructions to generate a set of locations in (x, y) coordinate format. The locations can also be generated as a vector of (x, y) coordinates when multi-sampling is in use. For a given frame, the sample generation logic should produce consistent locations for a given sample if subsequent depth and/or stencil tests are to be meaningful. Accordingly, the sample position that is generated for a given pixel should be deterministic for a given sample location on the screen. Otherwise, the generation of sample positions is at the discretion of the graphics application developer and the sample positions can be generated using any number of developer-supplied algorithms. For example, a set of sample positions for a frame can be pre-generated and the sample position selection logic can reference a lookup table for each pixel position. Alternatively, the sample positions can be generated algorithmically at runtime using shader logic executed by the pixel shader unit 1306.

Once the sample positions are selected, the pixel shader unit 1306 can evaluate the edge equations for all edges for the generated sample location or locations. If the sample location is found to be inside the triangle, attribute interpolation is performed at the sample position (x, y) sample positions (vector (x, y)) and a pixel shader is executed at the sample location(s). If the sample falls on the edge, the pixel shader unit 1306 can be configured to use one of available rasterization rules. For example, the Top-Left rule can be used to determine inclusion for edge samples. If the sample for the pixel is not included within the triangle, the pixel may be discarded. For the multi-sampling case, if all samples in (vector (x, y)) are found to be outside of the triangle, the pixel may be discarded. Otherwise, the pixel shader unit 1306 can be used to evaluate pixel shader logic for any sample locations (x, y) in the (vector (x, y,)) of sample locations that pass the triangle coverage test.

Table 1 below shows exemplary pseudo-code for logic that can be executed within the pixel shader unit 1306 to perform pixel shading with sample positions determined via developer supplied pixel shader logic. The exemplary pseudo-code is shown for the non-MSAA case. For MSAA, a loop can be performed to repeat the sample placement and pixel shading operations.

TABLE 1
Exemplary Sample Placement within a Pixel Shader

| // Pixel shader that takes in edge coefficients as system | |
|---|---|
| // variables with the semantic SV_Edge(A\|B\|C) • | |
| float4 PS(....., | // attributes |

float A[3] : SV_Edge_A, // Step 2
float B[3] : SV_Edge_B, // Step 2
float C[3] : SV_Edge_C))// Step 2

| { | |
|---|---|
| PlaceSample(x, y) | // Step 3 |

if ( (A[0]x + B[0]y + C[0] < 0) && // Step 4...edge 0 test

(A[1]x + B[1]y + C[1] < 0) && // Step 4...edge 1 test
(A[2]x + B[2]y + C[2] < 0) || // Step 4...edge 2 test
// Step 4..On the edge, but inside as per Top-Left Rule
IsInsideAsPerTopLeftRule(A, B, C, x, y))

| { | |
|---|---|
| // Interpolate the attributes using | // Step 5 |

| | |
|---|---|
| // EvaluateAttributeSnapped | // Step 5 |
| // Shade the pixel | // Step 5 |
| return float4(color.xyz, alpha); | // Step 5 |

} else
{

| | |
|---|---|
| discard; | // Step 6 |

}

Table 1 shows a pixel shader that accepts edge coefficients 1305 as system variables using the semantic SV_Edge (A|B|C). The exemplary pixel shader is a Microsoft Direct 3D® pixel shader, although embodiments described herein are not limited to any particular graphics API. The PlaceSample (x, y) function is used to place a sample at a determined (x, y) coordinate based on sample determination logic provided by the developer of a graphics application that executes using the graphics pipeline 1300. If the sample (or samples) are found to be inside the triangle, the shader programmer can use the pull mode interpolation (e.g. EvaluateAttributeSnapped) followed by the shading calculations at that sample location(s). Otherwise, if the desired sample is found to be outside of the triangle, pixel is discarded. If the sample(s) are found to be on the triangle edge, the shader programmer can use the same rule that are used by a conventional rasterizer, such as the Top-Left rule for Direct3D®.

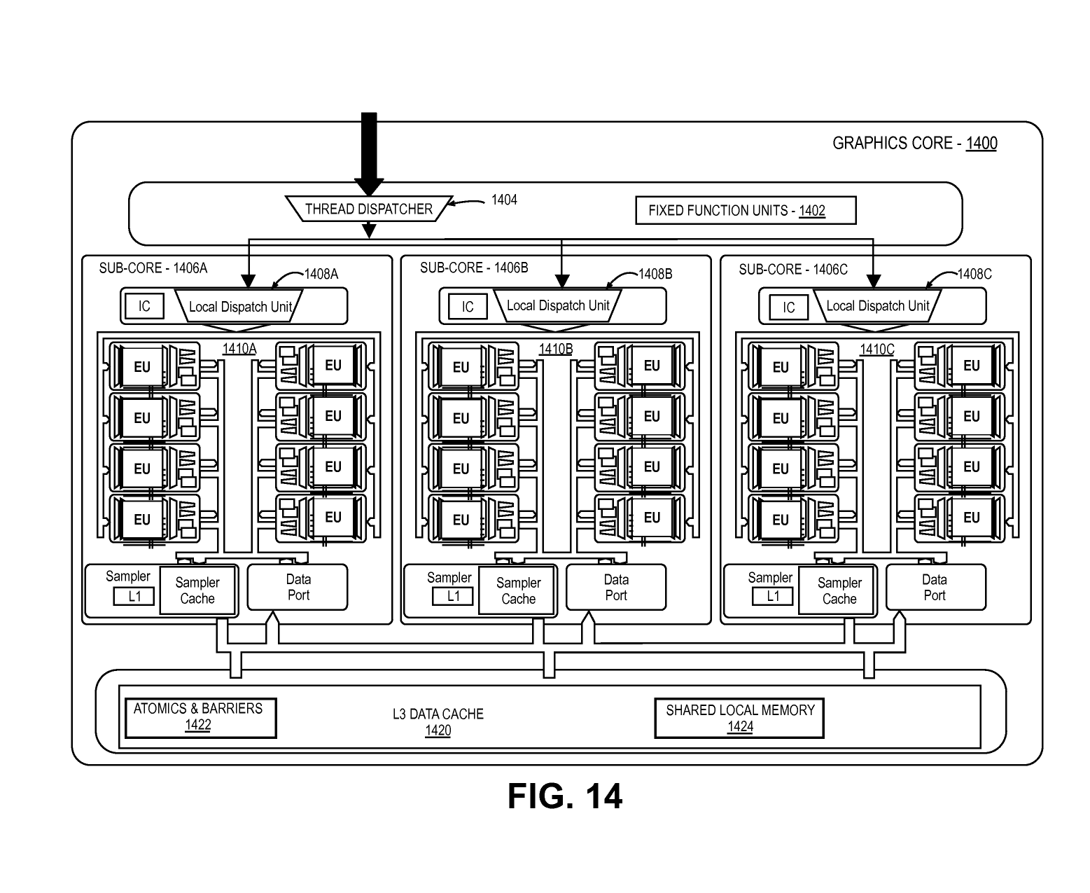

FIG. 14 is a detailed block diagram of graphics core logic, according to an embodiment. In one embodiment the graphics core 1400 (e.g., slice) includes a cluster of sub-cores 1406A-C, which may be variants of the sub-cores 550A-N. In one embodiment the graphics core includes a set of fixed function units 1402, for example, to support media and two-dimensional graphics functionality. For programmable graphics and computational processing, a thread dispatcher 1404 can dispatch execution threads to the various sub-cores 1406A-C, where a local dispatch unit 1408A-C dispatches execution threads to the execution unit groups 1410A-C in each of the sub-cores 1406A-C. The number of execution units in each of the groups 1410A-C can vary among embodiments. Execution units within each group 1410A-C can also be dynamically enabled or disabled based on workload, power, or thermal conditions.

In one embodiment, each execution unit in the graphic execution unit groups 1410A-C includes instruction fetch logic, an array of general register files, an array of architectural register files, a thread arbiter, a send unit, a branch unit, and a set of SIMD floating point units (FPUs). Multiple simultaneous hardware threads may be active in each execution unit, with the execution state of each thread, including the instruction pointers for each thread, held in thread-specific registers in the architectural register files.

In one embodiment, a level-3 (L3) data cache 1420 is shared between each of the sub-cores 1406A-C. In one embodiment the L3 data cache 1420 additionally includes an atomics & barriers unit 1422 and shared local memory 1424. In one embodiment the atomics & barriers unit 1422 includes dedicated logic to support implementation of barriers across groups of threads. The atomics & barriers unit 1422 is available as a hardware alternative to pure compiler based barrier implementation. Additionally, the atomics & barriers unit 1422 enables a suite of atomic read-modify-write memory operations to the L3 data cache 1420 or to the shared local memory 1424. Atomic operations to global memory can be supported via the L3 data cache 1420.

In one embodiment, the shared local memory 1424 supports programmer managed data for sharing amongst hardware threads, with access latency similar to the access latency to the L3 data cache 1420. In one embodiment, the shared local memory 1424 sharing is limited to between threads within the same sub-core 1406A-C, however, not all embodiments share such limitation. Constructs such as the local memory space in OpenCL or DirectX Compute Shader shared memory space can be shared across a single work-group (e.g., thread-group). For software kernel instances that use shared local memory, driver runtimes typically map all instances within a given work-group to an execution unit thread within a sub-core 1406A-C. Accordingly, all kernel instances within a work-group can share access to the same partition within the shared local memory 1424. In such embodiment, an application's accesses to shared local memory can scale with the number of sub-cores 1406A-C.

In one embodiment, shader programs are executed using a single program multiple data (SPMD) programming model. Using SPMD, a developer can author a graphics or compute shader as if the program were to operate on a single data element (e.g., a pixel or sample for a pixel shader, for example). The underlying hardware and runtime system can then execute multiple invocations of the program in parallel with different inputs (e.g., the values for different pixels or samples). The pixel shader unit (e.g., pixel shader unit 1306 of FIG. 13) can leverage the processing power of the graphics core 1400 to execute complex shader programs, including shader programs to calculate per-pixel sample positions for each graphics frame.

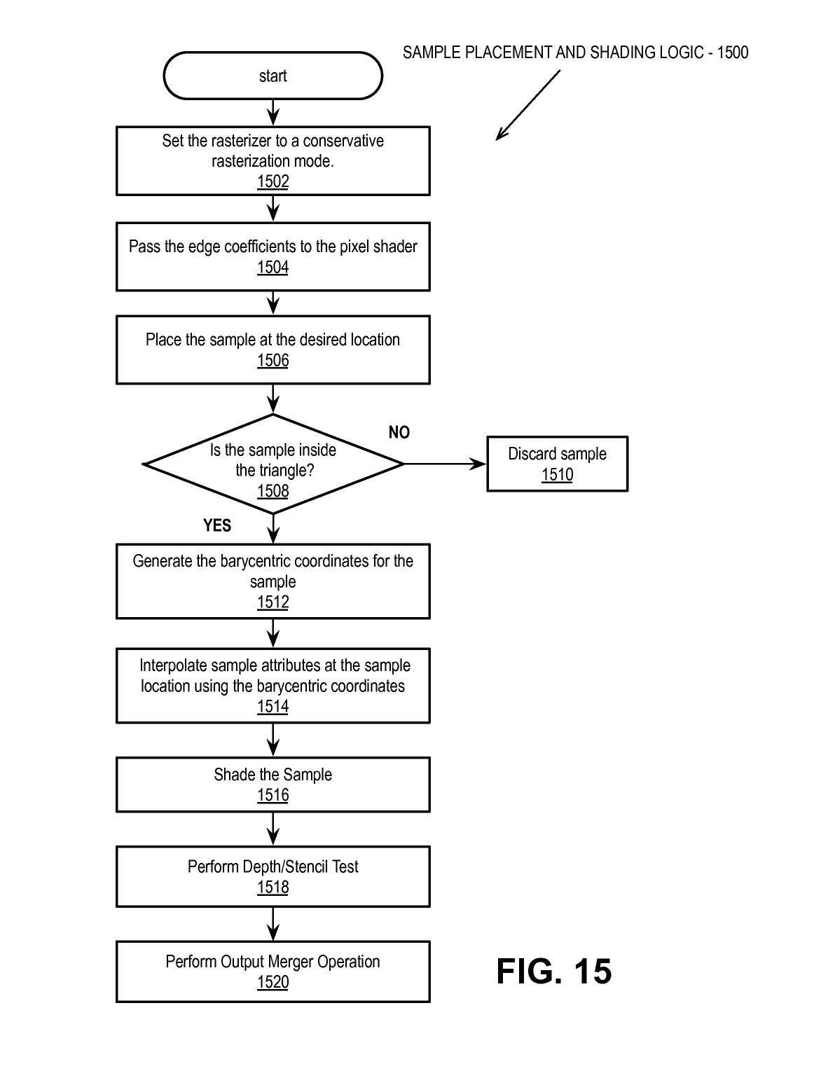

FIG. 15 is a flow diagram of sample placement and shading logic 1500, according to an embodiment. The sample placement and shading logic 1500 can be performed by shader logic executed by a pixel shader as described herein, such as pixel shader unit 1306 as in FIG. 13. Graphics processing hardware such as the graphics pipeline 1300 of FIG. 13 can be used to perform the sample placement and shading logic 1500. The precise operations of the graphics pipeline can be determined in part by shader instructions 1012 of a 3D graphics application 1010 as in FIG. 10. For example, a pixel shader unit (e.g., pixel shader unit 1306) can execute shader instructions via execution logic (e.g., execution logic 600 as in FIG. 6 or execution unit groups 1410A-C as in FIG. 14) provided by a graphics core, such as the exemplary graphics cores of FIG. 5 and FIG. 14.

In one embodiment the sample placement and shading logic 1500 is configured to set the rasterizer to a conservative rasterization mode, as shown at block 1502. The conservative rasterization mode can use a variant of the outer conservative rasterization algorithm that is adapted for use within pixel shader engines. At block 1504 the sample placement and shading logic 1500 can pass edge coefficients to the pixel shader. The edge coefficients can be the post-clipping edge coefficients that are clipped by a bounding box generated around the triangle used for the pixel coverage test.

At block 1506 the sample placement and shading logic 1500 can place the sample at the desired location. The sample can be placed at the desired location using pixel shader logic that executes shader instructions supplied by an application developer. The specific algorithm used to determine the sample locations is at the discretion of the application developer, within certain determinism constraints. The sample position that is generated for a given pixel should be deterministic per-viewpoint for a given pixel location on the screen, for example, to enable subsequent depth or stencil testing using those generated sample positions. However, the sample positions may vary on a frame-by-frame basis and may vary between viewpoints for a given frame.

At block 1508 the sample placement and shading logic 1500 performs a coverage check to determine if the sample is inside of the triangle. If the sample is not inside of the triangle, the sample can be discarded. If the sample is inside of the triangle, shader operations continue at block 1512. A determination can be made for each sample within a pixel if multiple samples are placed within the pixel. The graphics processing hardware may provide one or more instructions to quickly perform triangle coverage testing. For example and in one embodiment, a pin (plane) instruction is provided to compute a component wise plane equation. Such instruction may be used with the sample position coordinates to quickly determine if the coordinate lie within the planes defined by the line equations created using the edge coefficients provided at block 1504.

At block 1512, the sample placement and shading logic 1500 generates the barycentric coordinates for the sample. The barycentric coordinates describe the location of the sample within the triangle as an affine combination of the triangle vertices. At block 1514, the sample placement and shading logic 1500 interpolates sample attributes at the sample location using the barycentric coordinates of the sample.

At block 1516, the sample placement and shading logic 1500 can perform operations to shade the pixel based on logic provided by pixel shader instructions. In one embodiment, when visibility is determined using multiple sample points per pixel, each sample is shaded. In one embodiment, only a single sample is shaded. The sample shading operations can be configured based on pipeline state or can be determined based on the pixel shader instructions provided to the sample placement and shading logic 1500.

At block 1518 the sample placement and shading logic 1500 can perform depth and stencil testing, which could not have been performed until after the sample positions are known. In one embodiment, the depth and stencil testing 1518 can be performed after the samples are placed and coverage testing is performed but before other shader operations are performed, enabling a shader bypass for occluded pixels. However, in one embodiment, shading is performed for each sample that is inside of the triangle and occluded samples and/or pixels are discarded.

At block 1520, the sample placement and shading logic 1500 can perform an output merger operation. The output merger generates the final rendered pixel color using a combination of pipeline state, pixel data generated at block 1516 when the sample is shaded, any existing content within the render target(s), and the output results to render target(s).

The sample placement and shading logic 1500 operations described above can be performed for each pixel in a frame.

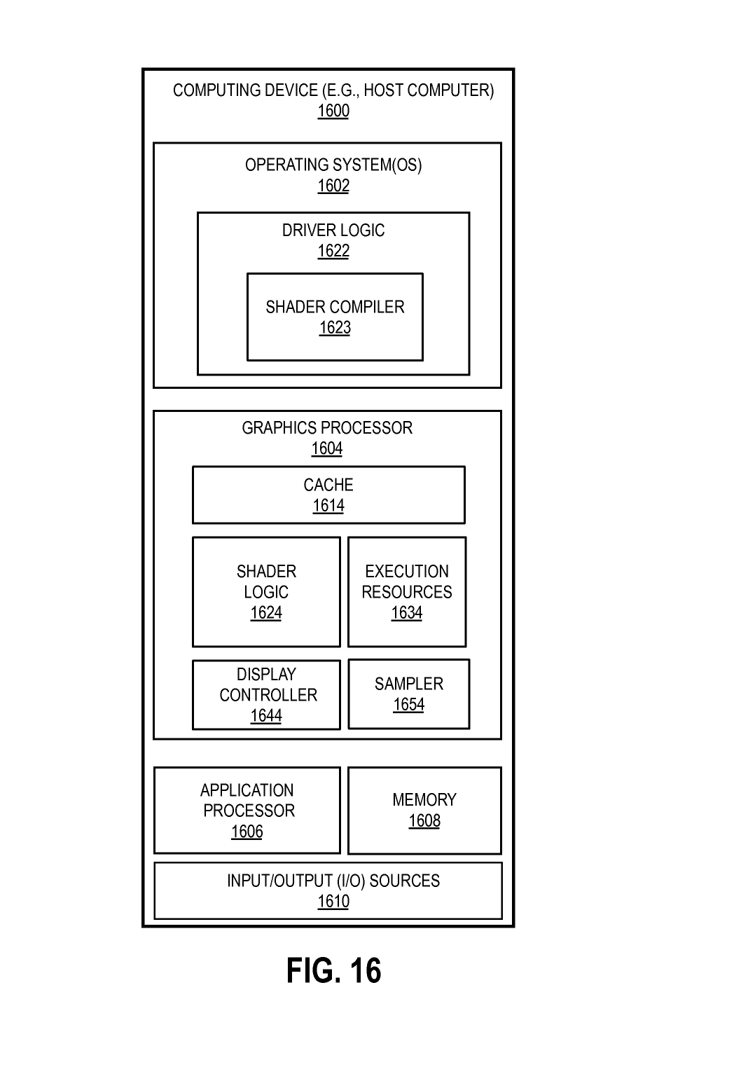

FIG. 16 is a block diagram of a computing device 1600 including a graphics pipeline configured to perform pixel shading with per pixel sample placement, according to an embodiment. Computing device 1600 (e.g., mobile computing device, desktop computer, etc.) may be the same as data processing system 100 of FIG. 1 and accordingly, for brevity and ease of understanding, many of the details stated above with reference to FIG. 1-10 are not further discussed or repeated hereafter.

Computing device 1600 may include a mobile computing device (e.g., smartphone, tablet computer, laptops, game consoles, portable workstations, etc.) serving as a host machine for a graphics processor 1604 having cache memory 1614 and shader logic 1624. The shader logic 1624 can include the pixel shader unit 1306 of FIG. 13 and/or the pixel shader 602 of FIG. 6. The shader logic 1624 can execute shader instructions using the execution resources 1634 of the graphics processor 1604. The execution resources can include the execution units 608A-N of FIG. 6, the execution units 852A-B of FIG. 8, the execution unit groups 1410A-C of FIG. 14, or any other graphics processor execution resource described herein. In one embodiment the execution resources 1634 can execute shader instructions in cooperation with an application processor 1606. In one embodiment the cache 1614 is the L3 data cache 1420 of FIG. 14. In one embodiment, in addition to an L3 cache, the cache memory 1614 can be an additional level of the memory hierarchy, such as a last level cache stored in the embedded memory module 218 of FIG. 2.

The computing device 1600 may include any number and type of communication devices, such as large computing systems, such as server computers, desktop computers, etc., and may further include set-top boxes (e.g., Internet-based cable television set-top boxes, etc.), global positioning system (GPS)-based devices, etc. The computing device 1600 may include mobile computing devices serving as communication devices, such as cellular phones including smartphones, personal digital assistants (PDAs), tablet computers, laptop computers, e-readers, smart televisions, television platforms, wearable devices (e.g., glasses, watches, bracelets, smartcards, jewelry, clothing items, etc.), media players, etc. For example, in one embodiment, the computing device 1600 includes a mobile computing device employing an integrated circuit (“IC”), such as system on a chip (“SoC” or “SOC”), integrating various hardware and/or software components of computing device 1600 on a single chip.

In one embodiment, the graphics processor 1604 includes a display controller 1644 and a sampler 1654, each configured to sample from and display framebuffer or other render target memory. In one embodiment, the display controller 1644 is a variant of the display controller 302 of FIG. 3 and/or the display engine 840 of FIG. 4. The sampler 1654, in one embodiment, is a variant of the sampler 854 of FIG. 8.

As illustrated, in one embodiment, in addition to a graphics processor 1604, the computing device 1600 may also include any number and type of hardware components and/or software components, such as (but not limited to) an application processor 1606, memory 1608, and input/output (I/O) sources 1610. The application processor 1606 can interact with a hardware graphics pipeline, as illustrated with reference to FIG. 3, to share graphics pipelining functionality. Processed data is stored in a buffer in the hardware graphics pipeline, and state information is stored in memory 1608. The resulting image is then transferred to a display component or device, such as display device 320 of FIG. 3, for displaying. It is contemplated that the display device may be of various types, such as Cathode Ray Tube (CRT), Thin Film Transistor (TFT), Liquid Crystal Display (LCD), Organic Light Emitting Diode (OLED) array, etc., to display information to a user.

The application processor 1606 can include one or processors, such as processor(s) 102 of FIG. 1, and may be the central processing unit (CPU) that is used at least in part to execute an operating system (OS) 1602 for the computing device 1600. The OS 1602 can serve as an interface between hardware and/or physical resources of the computer device 1600 and a user. The OS 1602 can include driver logic 1622 including the user mode graphics driver 1026 and/or kernel mode graphics driver 1029 of FIG. 10. The driver logic 1622 can have additional shader compiler logic 1623 (e.g., a shader compiler unit) including optimizations to improve the performance and/or efficiency of shader operations described herein. The shader compiler logic 1623 can be a version of the shader compiler 1024 and/or shader compiler 1027 of FIG. 10.

It is contemplated that in some embodiments, the graphics processor 1604 may exist as part of the application processor 1606 (such as part of a physical CPU package) in which case, at least a portion of the memory 1608 may be shared by the application processor 1606 and graphics processor 1604, although at least a portion of the memory 1608 may be exclusive to the graphics processor 1604, or the graphics processor 1604 may have a separate store of memory. The memory 1608 may comprise a pre-allocated region of a buffer (e.g., framebuffer); however, it should be understood by one of ordinary skill in the art that the embodiments are not so limited, and that any memory accessible to the lower graphics pipeline may be used. The memory 1608 may include various forms of random access memory (RAM) (e.g., SDRAM, SRAM, etc.) comprising an application that makes use of the graphics processor 1604 to render a desktop or 3D graphics scene. A memory controller hub, such as memory controller hub 116 of FIG. 1, may access data in the RAM and forward it to graphics processor 1604 for graphics pipeline processing. The memory 1608 may be made available to other components within the computing device 1600. For example, any data (e.g., input graphics data) received from various I/O sources 1610 of the computing device 1600 can be temporarily queued into memory 1608 prior to their being operated upon by one or more processor(s) (e.g., application processor 1606) in the implementation of a software program or application. Similarly, data that a software program determines should be sent from the computing device 1600 to an outside entity through one of the computing system interfaces, or stored into an internal storage element, is often temporarily queued in memory 1608 prior to its being transmitted or stored.

The I/O sources can include devices such as touchscreens, touch panels, touch pads, virtual or regular keyboards, virtual or regular mice, ports, connectors, network devices, or the like, and can attach via an input/output (I/O) control hub (ICH) 130 as referenced in FIG. 1. Additionally, the I/O sources 1610 may include one or more I/O devices that are implemented for transferring data to and/or from the computing device 1600 (e.g., a networking adapter); or, for a large-scale non-volatile storage within the computing device 1600 (e.g., hard disk drive). User input devices, including alphanumeric and other keys, may be used to communicate information and command selections to graphics processor 1604. Another type of user input device is cursor control, such as a mouse, a trackball, a touchscreen, a touchpad, or cursor direction keys to communicate direction information and command selections to GPU and to control cursor movement on the display device. Camera and microphone arrays of the computer device 1600 may be employed to observe gestures, record audio and video and to receive and transmit visual and audio commands.

I/O sources 1610 configured as network interfaces can provide access to a network, such as a LAN, a wide area network (WAN), a metropolitan area network (MAN), a personal area network (PAN), Bluetooth, a cloud network, a cellular or mobile network (e.g., 3^{rd} Generation (3G), 4^{th} Generation (4G), etc.), an intranet, the Internet, etc. Network interface(s) may include, for example, a wireless network interface having one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Network interface(s) may provide access to a LAN, for example, by conforming to IEEE 802.11 standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface(s) may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

It is to be appreciated that a lesser or more equipped system than the example described above may be preferred for certain implementations. Therefore, the configuration of the computing device 1600 may vary from implementation to implementation depending upon numerous factors, such as price constraints, performance requirements, technological improvements, or other circumstances. Examples include (without limitation) a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any one or a combination of: one or more microchips or integrated circuits interconnected using a parent-board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The following clauses and/or examples pertain to specific embodiments or examples thereof. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system according to embodiments and examples described herein. Various components can be a means for performing the operations or functions described.

One embodiment described herein includes a graphics processing apparatus comprising a graphics processing pipeline. The graphics processing pipeline includes shader execution logic to execute shading instructions. The shading instructions cause the shader execution logic to programmatically determine a sample location for a set of pixels within a frame. The sample locations are determined based on a location of each pixel within the frame and can be determined by shader logic provided to the graphics processing apparatus by a graphics application. The shader execution logic can programmatically determine the sample locations without the used of dedicated and/or fixed function sample placement hardware, as the sample placement can be performed within the pixel shader using pixel shader logic. In one embodiment the relative sample location within each pixel can differ for each pixel in the set of pixels. In other words, the location of the sample(s) within each pixel can vary pixel to pixel for a given viewpoint.

In one embodiment the graphic processing pipeline includes additional logic to determine whether a positioned sample lies inside of a geometric primitive based on a set of edge coefficients provided for the geometric primitive. The additional logic can be provided by shader instructions executed by the shader execution logic. In one embodiment the graphics processing apparatus provides a hardware instruction, such as a plane (e.g., pin) instruction, to accelerate determination of whether the positioned sample lies inside of the geometric primitive. In one embodiment the graphics processing pipeline includes interpolation logic to interpolate sample attributes for a positioned sample that lies inside of the geometric primitive. In response to a determination that all samples associated with a pixel lie outside of the geometric primitive used for coverage testing, the shader execution logic can discard the pixel. If the positioned sample lies inside of the geometric primitive, the shader execution logic can execute shading instructions for the pixel. In one embodiment the shader execution logic can determine an output value for each positioned sample within the pixel before the shader execution logic is to determine a final output value for the pixel.

One embodiment provides a method of performing a process to determine an output value for a pixel during a conservative rasterization operation using programmatically derived sample locations, the process including executing shader instructions to programmatically derive at least one sample location for the pixel based on coordinates for the pixel; based on the at least one sample location, performing a coverage test for the pixel based on the at least one sample location and a set of edge coefficients provided for a geometric primitive; and based on the coverage test for the pixel, execute pixel shading logic for the pixel. In one embodiment the process additionally includes generating barycentric coordinates for a sample based on the at least one sample location and interpolating sample attributes at the at least one sample location based on the barycentric coordinates before executing the pixel shading logic for the pixel. The multiple sample locations can be programmatically derived for the pixel and the pixel shading logic can execute for the pixel if at least one of the multiple sample locations is determined to be covered by the coverage test.

One embodiment provides graphics processing method including determining a sample location within a pixel based on a screen space location of the pixel from a viewpoint; positioning a sample point within the pixel at the sample location; determining whether the sample point lies at least partially inside of a geometric primitive; and determining an output value for the pixel in response to a determination that at the sample point lies within the geometric primitive. In a further embodiment the method additionally includes configuring a rasterization mode for a graphics processing apparatus to conservative rasterization mode, or otherwise enabling a conservative rasterizer of a graphics processing apparatus. In one embodiment determining whether the sample point lies at least partially inside of the geometric primitive includes receiving a set of edge coefficients associate with the geometric primitive and performing a coverage test for the sample point using the set of edge coefficients. Performing the coverage test for the sample point can include the use of a dedicated instruction provided by a graphics processing apparatus. However, positioning the samples does not include the use of any dedicated hardware for positioning samples and can be performed entirely by pixel shader logic executing pixel shader instructions provided by an application developer.

In one embodiment a set of sample locations within each pixel can be determined and multiple sample points can be positioned per pixel. An output value for the pixel can be determined if at least one of the multiple samples is covered (e.g., lies within) the geometric primitive. In one embodiment determining an output value for the pixel based on a color value determined for multiple sample points within the pixel.

The processes and methods described herein can be performed by a graphics processing apparatus when executing instructions stored on a machine readable storage medium, such that the instructions cause the graphics processing apparatus to perform the process. In one embodiment, a non-transitory machine readable medium stores data which, when read by one or more machines, causes the one or more machines to fabricate one or more integrated circuits to perform a process or method as described above. In general, various components can be a means for performing the operations, functions, and processes as described. Each component described herein includes software, hardware, or a combination of these. The components can be implemented as software modules, hardware modules, special-purpose hardware (e.g., application specific hardware, application specific integrated circuits (ASICs), DSPs, etc.), embedded controllers, hardwired circuitry, etc.

For example, in one embodiment a data processing system is provided to perform a process to determine an output value for a pixel during a conservative rasterization operation using programmatically derived sample locations. The system comprises a set of one or more processors coupled to memory. In one embodiment the set of processors includes an application processor and a graphics processor. The set of processors can programmatically derive a sample location for the pixel based on a set of coordinates for the pixel, perform a coverage test for the pixel based on the sample location and a set of edge coefficients provided for a geometric primitive, and based on the coverage test for the pixel, execute pixel shading logic for the pixel. In one embodiment the set of processors can to execute shader instructions that cause the set of processors to programmatically derive the sample location for the pixel. The set of processors can be configured to generate barycentric coordinates for a sample based on the sample location and interpolate sample attributes at the sample location based on the barycentric coordinates before execution of the pixel shading logic for the pixel. Additionally, the set of processors can programmatically derive multiple sample locations for the pixel and the pixel shading logic is executed for the pixel if at least one of the multiple sample locations is determined to be covered by the coverage test. The set of processors can execute the pixel shading logic to determine an output value for the pixel in response to a determination that at least one of the multiple sample locations lies inside of the geometric primitive and determine an output value for each positioned sample within the pixel before the pixel shading logic is to determine a final output value for the pixel.

Those skilled in the art will appreciate from the foregoing description that the broad techniques of the embodiments can be implemented in a variety of forms. Besides what is described herein, various modifications can be made to the disclosed embodiments and implementations without departing from their scope. Therefore, while the embodiments have been described in connection with particular examples thereof, the true scope of the embodiments should not be so limited since other modifications will become apparent to the skilled practitioner upon a study of the drawings, specification, and following claims. Accordingly, the illustrations and examples herein should be construed in an illustrative, and not a restrictive sense. The scope and spirit of the invention should be measured solely by reference to the claims that follow.

What is claimed is:

1. A graphics processing apparatus comprising:
a graphics processing pipeline including shader execution logic to execute shading instructions, the shading instructions to cause the shader execution logic to programmatically determine a sample location for a set of pixels within a frame, wherein the sample locations are determined for each pixel based on a location of the pixel within the frame.

2. The graphics processing apparatus of claim 1, wherein the shader execution logic is to programmatically determine the sample locations without fixed function sample placement hardware.

3. The graphics processing apparatus of claim 1, wherein a relative sample location within each pixel differs for each pixel in the set of pixels.

4. The graphics processing apparatus of claim 1, wherein the graphic processing pipeline includes additional logic to determine whether a positioned sample lies inside of a geometric primitive based on a set of edge coefficients provided for the geometric primitive.

5. The graphics processing apparatus of claim 4, wherein the additional logic is provided by shader instructions executed by the shader execution logic.

6. The graphics processing apparatus of claim 4, wherein the graphics processing apparatus provides a hardware instruction to accelerate determination of whether the positioned sample lies inside of the geometric primitive.

7. The graphics processing apparatus of claim 6, wherein the graphics processing pipeline includes interpolation logic to interpolate sample attributes for a positioned sample that lies inside of the geometric primitive.

8. The graphics processing apparatus of claim 6, wherein the shader execution logic is to discard a pixel associated with the positioned sample in response to the determination that the positioned sample lies outside of the geometric primitive.

9. The graphics processing apparatus of claim 8, wherein the shader execution logic is further to execute shading instructions to determine an output value for the pixel in response to the determination that the positioned sample lies inside of the geometric primitive.

10. The graphics processing apparatus of claim 9, wherein the shader execution logic is to determine an output value for each positioned sample within the pixel before the shader execution logic is to determine a final output value for the pixel.

11. A non-transitory machine readable medium storing instructions which, when executed by a graphics processing apparatus, cause the graphics processing apparatus to perform operations including:
determining a sample location within a pixel based on a screen space location of the pixel from a viewpoint;
positioning a sample point within the pixel at the sample location;
determining whether the sample point lies at least partially inside of a geometric primitive; and
determining an output value for the pixel in response to a determination that at the sample point lies within the geometric primitive.

12. The non-transitory machine readable medium of claim 11, the operations additionally including configuring a rasterization mode for the graphics processing apparatus to conservative rasterization mode.

13. The non-transitory machine readable medium of claim 11, wherein determining whether the sample point lies at least partially inside of the geometric primitive includes receiving a set of edge coefficients associated with the geometric primitive and performing a coverage test for the sample point using the set of edge coefficients.

14. The non-transitory machine readable medium of claim 13, wherein performing the coverage test for the sample point includes the use of a hardware instruction provided by the graphics processing apparatus.

15. The non-transitory machine readable medium of claim 11, the operations additionally including determining a set of sample locations within the pixel and positioning multiple sample points within the pixel at the set of sample locations.

16. The non-transitory machine readable medium of claim 15, the operations additionally comprising determining an output value for the pixel in response to a determination that at least one of the multiple sample points lie within the geometric primitive.

17. The non-transitory machine readable medium of claim 16, the operations additionally comprising determining an output value for the pixel based on a color value determined for multiple sample points within the pixel.

18. A system to determine an output value for a pixel during a conservative rasterization operation via one or more programmatically derived sample locations, the system including:
one or more processors on a system on a chip integrated circuit, the one or more processors including a graphics processor to programmatically derive the one or more sample locations for the pixel based on coordinates for the pixel, perform a coverage test for the pixel based on the one or more sample locations and a set of edge coefficients provided for a geometric primitive, and execute pixel shading logic for the pixel based on the coverage test for the pixel.

19. The system as in claim 18, wherein the graphics processor is additionally to generate barycentric coordinates based on the one or more programmatically derived sample location and interpolate sample attributes at the one or more sample location based on the barycentric coordinates before the pixel shading logic is executed for the pixel.

20. The system as in claim 19, wherein the graphics processor is to programmatically derive multiple sample locations for the pixel and execute the pixel shading logic for the pixel if at least one of the multiple sample locations are determined to be covered by the coverage test.
